(19) United States
(12) Patent Application Publication
(10) Pub. No.: US 2019/0349280 A1
(43) Pub. Date: Nov. 14, 2019

(54) RANGE MEASUREMENT WITH CLOSED-LOOP FEEDBACK ON RTT QUALITY

(71) Applicant: QUALCOMM Incorporated, San Diego, CA (US)

(72) Inventors: Xiaoxin ZHANG, Sunnyvale, CA (US); Sandip HOMCHAUDHURI, San Jose, CA (US); Erik David LINDSKOG, Cupertino, CA (US); Vincent Knowles JONES, IV, Redwood City, CA (US); Andrew MacKinnon DAVIDSON, Monte Sereno, CA (US)

(21) Appl. No.: 16/406,796

(22) Filed: May 8, 2019

Related U.S. Application Data
(60) Provisional application No. 62/669,209, filed on May 9, 2018.

(51) Int. Cl. H04L 12/26; H04B 17/26; H04B 17/327

(52) U.S. Cl. CPC H04L 43/0864; H04L 43/50; H04L 43/0882; H04B 17/327; H04B 17/26

(57) ABSTRACT

An apparatus is disclosed according to certain aspects of the present disclosure. The apparatus comprises an interface configured to receive, from a wireless node, at least one ranging frame. The apparatus also comprises a processing system configured to determine at least one round trip time (RTT) between the apparatus and the wireless node based on the received at least one ranging frame, determine a quality of the at least one RTT based on the received at least one ranging frame, and generate a feedback frame comprising the at least one RTT and the quality of the at least one RTT. The interface is further configured to output a feedback frame for transmission to the wireless node.

### PRIORITY

This application claims priority to and the benefit of U.S. Provisional Patent Application No. 62/669,209 filed in the U.S. Patent and Trademark Office on May 9, 2018, the entire content of which is incorporated herein by reference as if fully set forth below in its entirety and for all applicable purposes.

### FIELD

Certain aspects of the present disclosure generally relate to wireless communications and, more particularly, to ranging in a wireless communication system.

### BACKGROUND

Two wireless devices in a wireless communication system may perform timing measurement procedures to measure a round trip time (RTT) between the devices (e.g., between an access point and an access terminal). The RTT may be used to estimate the range between the wireless devices.

### SUMMARY

A first aspect relates to an apparatus for wireless communications. The apparatus comprises an interface configured to receive, from a wireless node, at least one timing measurement or ranging frame. The apparatus also comprises a processing system configured to determine at least one round trip time (RTT) between the apparatus and the wireless node based on the received at least one timing measurement or ranging frame, determine a quality of the at least one RTT based on the received at least one timing measurement or ranging frame, and generate a feedback frame comprising the at least one RTT and the quality of the at least one RTT. The interface is further configured to output the feedback frame for transmission to the wireless node.

A second aspect relates to a method for wireless communications. The method comprises receiving, from a wireless node, at least one timing measurement or ranging frame, determining at least one round trip time (RTT) between an apparatus and the wireless node based on the received at least one timing measurement or ranging frame, determining a quality of the at least one RTT based on the received at least one timing measurement or ranging frame, generating a feedback frame comprising the at least one RTT and the quality of the at least one RTT, and outputting the feedback frame for transmission to the wireless node.

A third aspect relates to an apparatus for wireless communications. The apparatus comprises means for receiving, from a wireless node, at least one timing measurement or ranging frame, means for determining at least one round trip time (RTT) between the apparatus and the wireless node based on the received at least one timing measurement or ranging frame, means for determining a quality of the at least one RTT based on the received at least one timing measurement or ranging frame, means for generating a feedback frame comprising the at least one RTT and the quality of the at least one RTT, and means for outputting the feedback frame for transmission to the wireless node.

A fourth aspect relates to a computer readable medium. The computer readable medium comprises instructions stored thereon for receiving, from a wireless node, at least one timing measurement or ranging frame, determining at least one round trip time (RTT) between an apparatus and the wireless node based on the received at least one timing measurement or ranging frame, determining a quality of the at least one RTT based on the received at least one timing measurement or ranging frame, generating a feedback frame comprising the at least one RTT and the quality of the at least one RTT, and outputting the feedback frame for transmission to the wireless node.

A fifth aspect relates to a wireless node. The wireless node comprises a receiver configured to receive, from another wireless node, at least one timing measurement or ranging frame. The wireless node also comprises a processing system configured to determine at least one round trip time (RTT) between the wireless node and the other wireless node based on the received at least one timing measurement or ranging frame, determine a quality of the at least one RTT based on the received at least one timing measurement or ranging frame, and generate a feedback frame comprising the at least one RTT and the quality of the at least one RTT. The wireless node further comprises a transmitter configured to transmit the feedback frame to the other wireless node.

A sixth aspect relates to an apparatus for wireless communications. The apparatus comprises a processing system configured to generate at least one timing measurement or ranging frame. The apparatus also comprises an interface configured to output the at least one timing measurement or ranging frame for transmission to a wireless node, and receive a feedback frame from the wireless node, the feedback frame comprising at least one round trip time (RTT) between the apparatus and the wireless node and a quality of the at least one RTT. The processing system is further configured to determine a range between the apparatus and the wireless node based on the at least one RTT and the quality of the at least one RTT.

A seventh aspect relates to a method for wireless communications. The method comprises generating at least one timing measurement or ranging frame, outputting the at least one timing measurement or ranging frame for transmission to a wireless node, receiving a feedback frame from the wireless node, the feedback frame comprising at least one round trip time (RTT) between an apparatus and the wireless node and a quality of the at least one RTT, and determining a range between the apparatus and the wireless node based on the at least one RTT and the quality of the at least one RTT.

An eighth aspect relates to an apparatus for wireless communications. The apparatus comprises means for generating at least one timing measurement or ranging frame, means for outputting the at least one timing measurement or ranging frame for transmission to a wireless node, means for receiving a feedback frame from the wireless node, the feedback frame comprising at least one round trip time (RTT) between the apparatus and the wireless node and a quality of the at least one RTT, and means for determining a range between the apparatus and the wireless node based on the at least one RTT and the quality of the at least one RTT.

A ninth aspect relates to a computer readable medium. The computer readable medium comprises instructions stored thereon for generating at least one timing measurement or ranging frame, outputting the at least one timing measurement or ranging frame for transmission to a wireless node, receiving a feedback frame from the wireless node, the feedback frame comprising at least one round trip time (RTT) between an apparatus and the wireless node and a quality of the at least one RTT, and determining a range between the apparatus and the wireless node based on the at least one RTT and the quality of the at least one RTT.

A tenth aspect relates to a wireless node. The wireless node comprises a processing system configured to generate at least one timing measurement or ranging frame. The wireless node also comprises a transmitter configured to transmit the at least one timing measurement or ranging frame to another wireless node, and a receiver configured to receive a feedback frame from the other wireless node, the feedback frame comprising at least one round trip time (RTT) between the wireless node and the other wireless node and a quality of the at least one RTT. The processing system is further configured to determine a range between the wireless node and the other wireless node based on the at least one RTT and the quality of the at least one RTT.

### BRIEF DESCRIPTION OF THE DRAWINGS

FIG. 1 illustrates an exemplary wireless communication system in accordance with certain aspects of the present disclosure.

FIG. 2 is a block diagram of an exemplary access point and access terminal in accordance with certain aspects of the present disclosure.

FIG. 3 shows an example of a process flow between an initiator and a responder that supports ranging in accordance with certain aspects of the present disclosure.

FIG. 4 shows an example in which the initiator transmits a feedback frame to the responder in accordance with certain aspects of the present disclosure.

FIG. 5 shows an exemplary format of a feedback frame that includes a round trip time (RTT) field for reporting an RTT to the responder in accordance with certain aspects of the present disclosure.

FIG. 6 shows an exemplary format of a feedback frame that includes optional fields for reporting RTT quality information to the responder in accordance with certain aspects of the present disclosure.

FIG. 7 shows an exemplary format of an RTT Quality element in accordance with certain aspects of the present disclosure.

FIG. 8 shows an exemplary format of a Per-Packet RTT element in accordance with certain aspects of the present disclosure.

FIG. 9 shows an exemplary format of a Per-Packet RTT Quality element in accordance with certain aspects of the present disclosure.

FIG. 10 shows an example of a feedback capabilities element for indicating feedback capabilities of the initiator in accordance with certain aspects of the present disclosure.

FIG. 11 shows an exemplary format of the feedback capabilities element in accordance with certain aspects of the present disclosure.

FIG. 12 shows an example of a feedback request element used by the responder to request that one or more fields be included in the feedback frame in accordance with certain aspects of the present disclosure.

FIG. 13 shows an exemplary format of the feedback request element in accordance with certain aspects of the present disclosure.

FIG. 14 is a plot of channel impulse response power versus time delay illustrating a method of using a first peak power to determine RTT quality in accordance with certain aspects of the present disclosure.

FIG. 15 is a plot of channel impulse response power versus time delay illustrating a method of using a first group peak power to determine RTT quality in accordance with certain aspects of the present disclosure.

FIG. 16 is a plot of channel impulse response power versus time delay illustrating a method of using a delay spread to determine RTT quality in accordance with certain aspects of the present disclosure.

FIG. 17 is a plot of channel impulse response power versus time delay illustrating a method of detecting the first arrival time of a frame in accordance with certain aspects of the present disclosure.

FIG. 18 is a flowchart of a method for wireless communications in accordance with certain aspects of the present disclosure.

FIG. 19 is a flowchart of another method for wireless communications in accordance with certain aspects of the present disclosure.

FIG. 20 illustrates an exemplary device in accordance with certain aspects of the present disclosure.

FIG. 21 illustrates an exemplary timing diagram of frame transmissions in a system utilizing NDP for range determination according to an aspect of the present disclosure.

FIG. 22 illustrates an exemplary timing diagram of feedback frames including measurement feedback from an ISTA to an RSTA in a system using NDP frames.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple access terminals. A TDMA system may allow multiple access terminals to share the same frequency channel by dividing the transmission signal into different time slots, each time slot being assigned to different access terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or be known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or be known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

With reference to the following description, it shall be understood that not only communications between access points and user devices are allowed, but also direct (e.g., peer-to-peer) communications between respective user devices are allowed. Furthermore, a device (e.g., an access point or user device) may change its behavior between a user device and an access point according to various conditions. Also, one physical device may play multiple roles: user device and access point, multiple user devices, multiple access points, for example, on different channels, different time slots, or both.

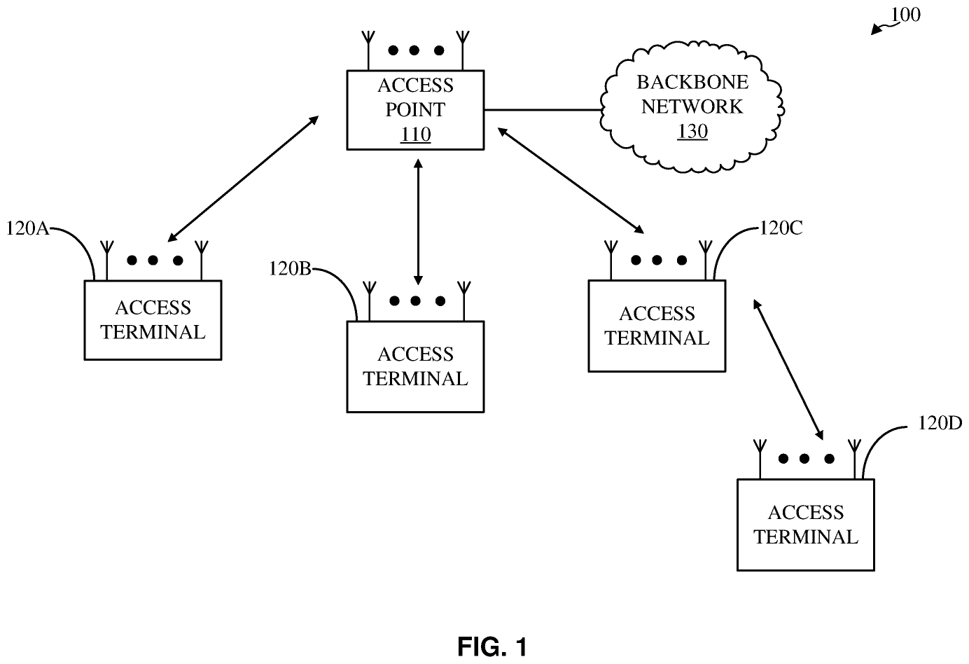

FIG. 1 illustrates an example of a wireless communication system 100 with access points and access terminals. For simplicity, only one access point 110 is shown in FIG. 1. An access point is generally a fixed station that communicates with the access terminals and may also be referred to as a base station or some other terminology. An access terminal may be fixed or mobile and may also be referred to as a mobile station, a wireless device or some other terminology. Access point 110 may communicate with one or more access terminals 120 at any given moment on the downlink and uplink. The downlink (i.e., forward link) is the communication link from the access point to the access terminals, and the uplink (i.e., reverse link) is the communication link from the access terminals to the access point. An access terminal may also communicate peer-to-peer with another access terminal (e.g., communication between 120A and 120B). The access point 110 may be coupled to a backbone network 130 (e.g., the Internet) to provide the access terminals 120 with access to the backbone network 130.

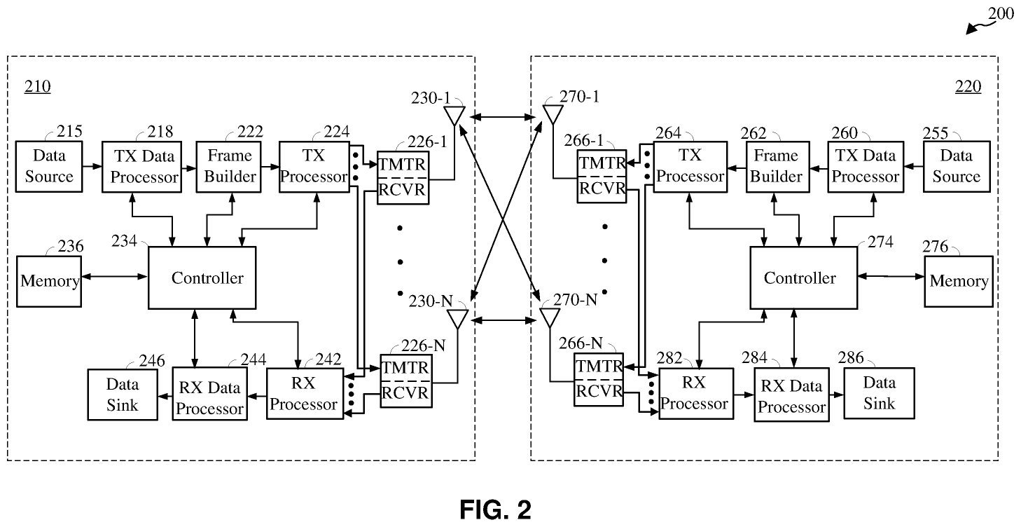

FIG. 2 illustrates a block diagram of an access point 210 (generally, a first wireless node) and an access terminal 220 (generally, a second wireless node) of the wireless communication system 200. The access point 210 is a transmitting entity for the downlink and a receiving entity for the uplink. The access terminal 220 is a transmitting entity for the uplink and a receiving entity for the downlink. As used herein, a “transmitting entity” is an independently operated apparatus or wireless node capable of transmitting data via a wireless channel, and a “receiving entity” is an independently operated apparatus or wireless node capable of receiving data via a wireless channel.

Although, in this example, wireless node 210 is an access point and wireless node 220 is an access terminal, it shall be understood that the wireless node 210 may alternatively be an access terminal, and wireless node 220 may alternatively be an access point. The wireless node 210 may be used to implement the access point 110 in FIG. 1, and the wireless node 220 may be used to implement any one of the access terminals 120 in FIG. 1.

For transmitting data, the access point 210 comprises a transmit data processor 218, a frame builder 222, a transmit processor 224, a plurality of transceivers 226-1 to 226-N, and a plurality of antennas 230-1 to 230-N. The access point 210 also comprises a controller 234 configured to control operations of the access point 210, as discussed further below.

In operation, the transmit data processor 218 receives data (e.g., data bits) from a data source 215, and processes the data for transmission. For example, the transmit data processor 218 may encode the data (e.g., data bits) into encoded data, and modulate the encoded data into data symbols. The transmit data processor 218 may support different modulation and coding schemes (MCSs). For example, the transmit data processor 218 may encode the data (e.g., using low-density parity check (LDPC) encoding) at any one of a plurality of different coding rates. Also, the transmit data processor 218 may modulate the encoded data using any one of a plurality of different modulation schemes, including, but not limited to, BPSK, QPSK, 16QAM, 64QAM, 64APSK, 128APSK, 256QAM, and 256APSK.

In certain aspects, the controller 234 may send a command to the transmit data processor 218 specifying which modulation and coding scheme (MCS) to use (e.g., based on channel conditions of the downlink), and the transmit data processor 218 may encode and modulate data from the data source 215 according to the specified MCS. It is to be appreciated that the transmit data processor 218 may perform additional processing on the data such as data scrambling, and/or other processing. The transmit data processor 218 outputs the data symbols to the frame builder 222.

The frame builder 222 constructs a frame (also referred to as a packet), and inserts the data symbols into a data payload of the frame. Exemplary frame structures or formats are discussed further below. The frame builder 222 outputs the frame to the transmit processor 224. The transmit processor 224 processes the frame for transmission on the downlink. For example, the transmit processor 224 may support different transmission modes such as an orthogonal frequency-division multiplexing (OFDM) transmission mode and a single-carrier (SC) transmission mode. In this example, the controller 234 may send a command to the transmit processor 224 specifying which transmission mode to use, and the transmit processor 224 may process the frame for transmission according to the specified transmission mode.

In certain aspects, the transmit processor 224 may support multiple-output-multiple-input (MIMO) transmission. In these aspects, the access point 210 includes multiple antennas 230-1 to 230-N and multiple transceivers 226-1 to 226-N (e.g., one for each antenna). The transmit processor 224 may perform spatial processing on the incoming frames and provide a plurality of transmit frame streams for the plurality of antennas. The transceivers 226-1 to 226-N receive and process (e.g., convert to analog, amplify, filter, and frequency upconvert) the respective transmit frame streams to generate transmit signals for transmission via the antennas 230-1 to 230-N.

For transmitting data, the access terminal 220 comprises a transmit data processor 260, a frame builder 262, a transmit processor 264, a plurality of transceivers 266-1 to 266-N, and a plurality of antennas 270-1 to 270-N. The access terminal 220 may transmit data to the access point 210 on the uplink, and/or transmit data to another access terminal (e.g., for peer-to-peer communication). The access terminal 220 also comprises a controller 274 configured to control operations of the access terminal 220, as discussed further below.

In operation, the transmit data processor 260 receives data (e.g., data bits) from a data source 255, and processes (e.g., encodes and modulates) the data for transmission. The transmit data processor 260 may support different MCSs. For example, the transmit data processor 260 may encode the data (e.g., using LDPC encoding) at any one of a plurality of different coding rates, and modulate the encoded data using any one of a plurality of different modulation schemes, including, but not limited to, BPSK, QPSK, 16QAM, 64QAM, 64APSK, 128APSK, 256QAM, and 256APSK. In certain aspects, the controller 274 may send a command to the transmit data processor 260 specifying which MCS to use (e.g., based on channel conditions of the uplink), and the transmit data processor 260 may encode and modulate data from the data source 255 according to the specified MCS. It is to be appreciated that the transmit data processor 260 may perform additional processing on the data. The transmit data processor 260 outputs the data symbols to the frame builder 262.

The frame builder 262 constructs a frame, and inserts the received data symbols into a data payload of the frame. Exemplary frame structures or formats are discussed further below. The frame builder 262 outputs the frame to the transmit processor 264. The transmit processor 264 processes the frame for transmission. For example, the transmit processor 264 may support different transmission modes such as an OFDM transmission mode and an SC transmission mode. In this example, the controller 274 may send a command to the transmit processor 264 specifying which transmission mode to use, and the transmit processor 264 may process the frame for transmission according to the specified transmission mode.

In certain aspects, the transmit processor 264 may support multiple-output-multiple-input (MIMO) transmission. In these aspects, the access terminal 220 includes multiple antennas 270-1 to 270-N and multiple transceivers 266-1 to 266-N (e.g., one for each antenna). The transmit processor 264 may perform spatial processing on the incoming frame and provide a plurality of transmit frame streams for the plurality of antennas. The transceivers 266-1 to 266-N receive and process (e.g., convert to analog, amplify, filter, and frequency upconvert) the respective transmit frame streams to generate transmit signals for transmission via the antennas 270-1 to 270-N.

For receiving data, the access point 210 comprises a receive processor 242, and a receive data processor 244. In operation, the transceivers 226-1 to 226-N receive signals (e.g., from the access terminal 220) via the antennas 230-1 to 230-N, and process (e.g., frequency downconvert, amplify, filter and convert to digital) the received signals.

The receive processor 242 receives the outputs of the transceivers 226-1 to 226-N, and processes the outputs to recover data symbols. For example, the access point 210 may receive data (e.g., from the access terminal 220) in a frame. In this example, the receive processor 242 may detect the start of the frame using the STF sequence in the preamble of the frame. The receive processor 242 may also use the STF for automatic gain control (AGC) adjustment. The receive processor 242 may also perform channel estimation (e.g., using the channel estimation (CE) sequence or field in the preamble of the frame) and perform channel equalization on the received signal based on the channel estimation.

The receive processor 242 may also recover information (e.g., MCS scheme) from the header of the frame, and send the information to the controller 234. After performing channel equalization, the receive processor 242 may recover data symbols from the frame, and output the recovered data symbols to the receive data processor 244 for further processing. It is to be appreciated that the receive processor 242 may perform other processing.

The receive data processor 244 receives the data symbols from the receive processor 242 and an indication of the corresponding MSC scheme from the controller 234. The receive data processor 244 demodulates and decodes the data symbols to recover the data according to the indicated MSC scheme, and outputs the recovered data (e.g., data bits) to a data sink 246 for storage and/or further processing.

As discussed above, the access terminal 220 may transmit data using an OFDM transmission mode or an SC transmission mode. In this case, the receive processor 242 may process the receive signal according to the selected transmission mode. Also, as discussed above, the transmit processor 264 may support multiple-input-multiple-output (MIMO) transmission. In this case, the access point 210 includes multiple antennas 230-1 to 230-N and multiple transceivers 226-1 to 226-N (e.g., one for each antenna). Each transceiver 226 receives and processes (e.g., frequency downconverts, amplifies, filters, and converts to digital) the signal from the respective antenna 230. The receive processor 242 may perform spatial processing on the outputs of the transceivers 226-1 to 226-N to recover the data symbols.

For receiving data, the access terminal 220 comprises a receive processor 282, and a receive data processor 284. In operation, the transceivers 266-1 to 266-N receive signals (e.g., from the access point 210 or another access terminal) via the antennas 270-1 to 270-N, and process (e.g., frequency downconvert, amplify, filter and convert to digital) the received signals.

The receive processor 282 receives the outputs of the transceivers 266-1 to 266-N, and processes the outputs to recover data symbols. For example, the access terminal 220 may receive data (e.g., from the access point 210 or another access terminal) in a frame, as discussed above. In this example, the receive processor 282 may detect the start of the frame using the short training field (STF) sequence in the preamble of the frame. The receive processor 282 may also perform channel estimation (e.g., using the CE sequence in the preamble of the frame) and perform channel equalization on the received signal based on the channel estimation.

The receive processor 282 may also recover information (e.g., MCS scheme) from the header of the frame, and send the information to the controller 274. After performing channel equalization, the receive processor 282 may recover data symbols from the frame, and output the recovered data symbols to the receive data processor 284 for further processing. It is to be appreciated that the receive processor 282 may perform other processing.

The receive data processor 284 receives the data symbols from the receive processor 282 and an indication of the corresponding MSC scheme from the controller 274. The receive data processor 284 demodulates and decodes the data symbols to recover the data according to the indicated MSC scheme, and outputs the recovered data (e.g., data bits) to a data sink 286 for storage and/or further processing.

As discussed above, the access point 210 or another access terminal may transmit data using an OFDM transmission mode or a SC transmission mode. In this case, the receive processor 282 may process the receive signal according to the selected transmission mode. Also, as discussed above, the transmit processor 224 may support multiple-output-multiple-input (MIMO) transmission. In this case, the access terminal 220 includes multiple antennas 270-1 to 270-N and multiple transceivers 266-1 to 266-N (e.g., one for each antenna). Each transceiver receives and processes (e.g., frequency downconverts, amplifies, filters, and converts to digital) the signal from the respective antenna. The receive processor 282 may perform spatial processing on the outputs of the transceivers to recover the data symbols.

As shown in FIG. 2, the access point 210 also comprises a memory 236 coupled to the controller 234. The memory 236 may store instructions that, when executed by the controller 234, cause the controller 234 to perform one or more of the operations described herein. Similarly, the access terminal 220 also comprises a memory 276 coupled to the controller 274. The memory 276 may store instructions that, when executed by the controller 274, cause the controller 274 to perform the one or more of the operations described herein.

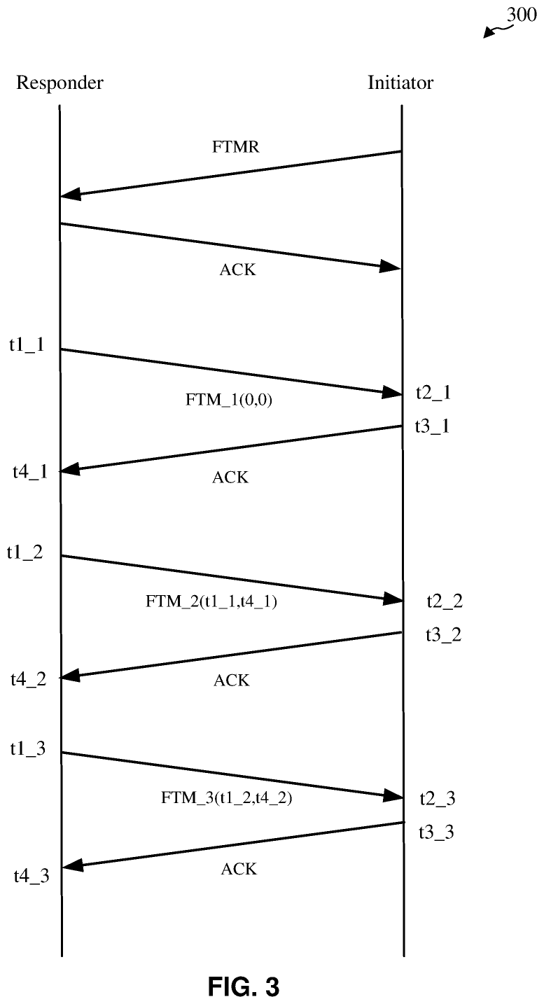

FIG. 3 shows an example of a process flow 300 of a sounding or ranging exchange for measuring the range between two wireless devices according to a fine timing measurement (FTM) protocol standardized in the IEEE 802.11REVmc standard. In this example, one of the wireless devices is referred to as an initiator or initiator station (ISTA) and the other wireless device is referred to as a responder or responder station (RSTA). The initiator may be an access point or an access terminal (e.g., access point 210 or access terminal 220), and the responder may be an access point or an access terminal (e.g., access point 210 or access terminal 220).

The initiator starts the process flow 300 by transmitting an FTM request frame (labeled “FTMR”) to the responder according to the IEEE 802.11REVmc standard. In response to the FTM request, the responder transmits an acknowledgment (labeled “ACK”) to the initiator acknowledging the FTM request.

After the FTM request (“FTMR”) and the acknowledgment (“ACK”), the responder starts transmitting FTM frames to the initiator, as shown in FIG. 3. For each received FTM frame, the initiator transmits a corresponding acknowledgement (“ACK”) to the responder in which the acknowledgement acknowledges reception of the FTM frame at the initiator. A first FTM frame (“FTM_1”) is transmitted by the responder at time 0_1 and received by the initiator at time t2_1, and an acknowledgement (“ACK”) of the first FTM frame is transmitted by the initiator at time t3_1 and received by the responder at time t4_1. A second FTM frame (“FTM_2”) is transmitted by the responder at time t1_2 and received by the initiator at time t2_2, and an acknowledgement (“ACK”) of the second FTM frame is transmitted by the initiator at time t3_2 and received by the responder at time t4_2. A third FTM frame (“FTM_3”) is transmitted by the responder at time t1_3 and received by the initiator at time t2_3, and an acknowledgement (“ACK”) of the third FTM frame is transmitted by the initiator at time t3_3 and received by the responder at time t4_3, and so forth. Although three FTM frames are shown in FIG. 3, it is to be appreciated that the responder may transmit additional FTM frames to the initiator with the initiator transmitting an acknowledgement for each additional FTM frame to the responder.

Each FTM frame after the first FTM frame may include timestamps indicating times t1 and t4 for the previous FTM frame (i.e., the time that the previous FTM was transmitted by the responder, and the time that the acknowledgement of the previous FTM was received by the responder). In this example, the second FTM frame (“FTM_2”) indicates times 0_1 and t4_1 for the first FTM frame (“FTM_1”), and the third FTM frame (“FTM_3”) indicates times t1_2 and t4_2 for the second FTM frame (“FTM_2”), and so forth.

The initiator may determine a round trip time (RTT) between the responder and the initiator using times t1, t2, t3 and t4 for an FTM frame and the corresponding acknowledgement. For example, the initiator may compute the RTT based on the following equation:

RTT=(t4−t1)−(t3−t2).

The initiator may determine an RTT for each one of multiple FTM frames, in which the initiator determines the RTT for each FTM frame using times t1, t2, t3 and t4 for the FTM frame and the corresponding acknowledgement. For example, the initiator may determine an RTT for the first FTM frame (“FTM_1”) using times 0_1, t2_1, t3_1 and t4_1 for the first FTM frame (“FTM_1”) and the corresponding acknowledgment, determine an RTT for the second FTM frame (“FTM_2”) using times t1_2, t2_2, t3_2 and t4_2 for the second FTM frame (“FTM_2”) and the corresponding acknowledgement, and so forth. Thus, the process flow 300 allows the initiator to compute multiple RTTs (e.g., one per FTM/ACK).

The initiator may combine multiple RTTs for the process flow 300 into a combined RTT. For example, the initiator may combine the RTTs by computing the average of the RTTs, taking the minimum one of the RTTs, or another method. Thus, the initiator may combine multiple RTTs for the process flow 300 into one RTT (i.e., the combined RTT).

The initiator may compute the range (e.g., the distance) between the responder and the initiator based on an RTT by multiplying RTT/2 by the wireless signal speed between the responder and initiator (e.g., approximately equal to the speed of light). In this example, the RTT used to compute the range may be an RTT computed from one FTM/ACK (i.e., an FTM frame and the corresponding ACK), or a combined RTT.

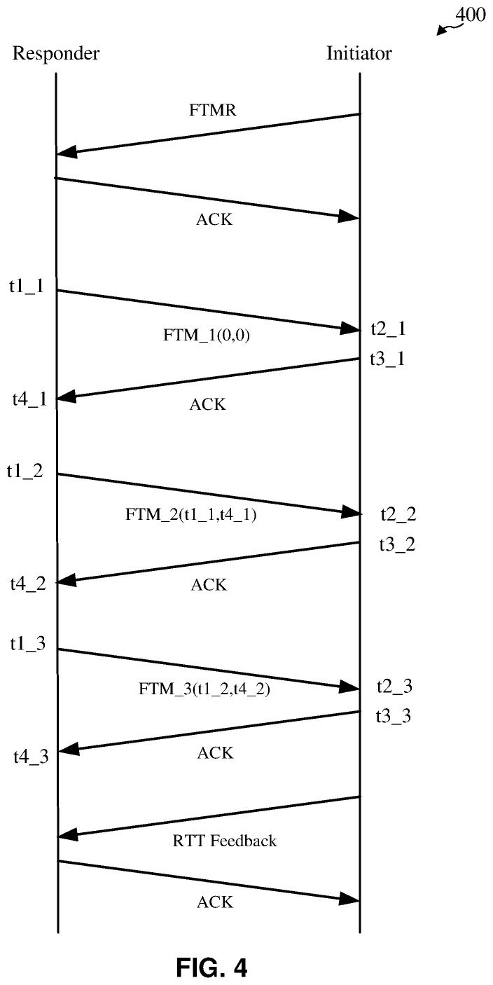

The initiator may feedback the combined RTT to the responder in an RTT Feedback frame. In this regard, FIG. 4 shows a process flow 400 in which the initiator transmits an RTT Feedback frame (“RTT Feedback”) to the responder after the last FTM/ACK in the current burst. The RTT Feedback frame includes the combined RTT so that both the responder and the initiator have the combined RTT. The combined RTT may be the average of the RTTs computed from the FTM/ACKs in the process flow 300 or the minimum one of the RTTs computed from the FTM/ACKs in the process flow 300. The combined RTT may also be determined using other methods, as discussed further below.

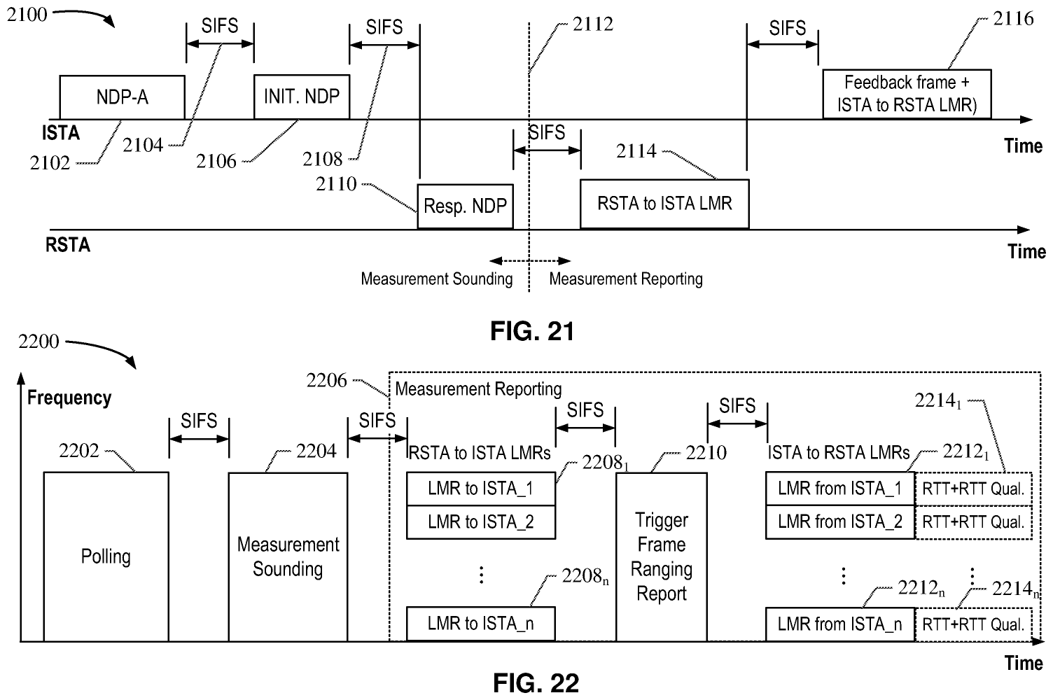

Additionally, it is noted that while the examples of FIGS. 3 and 4 illustrate the determination of the RTT and, ultimately, a range, using frames configured according to the proposed IEEE 802.11REVmc standard using an FTM frame protocol, the presently disclosed methods and apparatus are applicable to other standards. As an example, the presently disclosed methods and apparatus may be implemented in systems operation according to IEEE 802.11az as one example, which utilizes null data packets (NDPs) for determining location or ranging and will be discussed in more detail with regard to FIGS. 21 and 22. In further aspects, it is also noted here that the present methods and apparatus providing RTT feedback frames including RTT measurements and RTT quality are applicable to systems and standards employing location measurement or ranging frames such as with FTMs or NDPs, and those skilled in the art will appreciate the applicability of the present disclosure to not just FTM or NDP, but also to a number of different systems or standards that employ location or ranging measurements. In still further aspects, it is noted that for purposes of the present disclosure, both a timing measurement frame using the FTM protocol and an NDP ranging frame may be characterized as a “range measurement frame” or “ranging frame” where such ranging frame is a frame used for RTT calculations as will be described in more detail below, and to determine range or location information based on such RTT calculations.

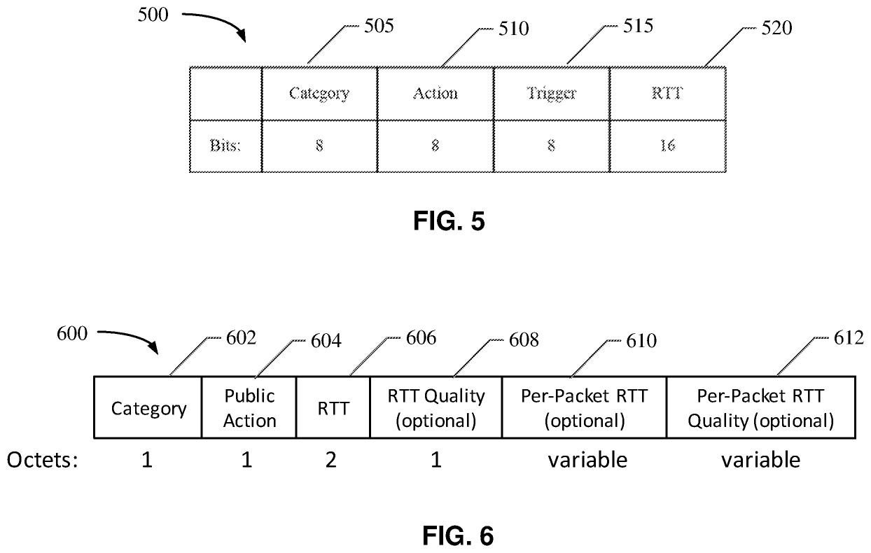

FIG. 5 shows an exemplary frame format for the RTT Feedback frame 500.

In this example, the RTT Feedback frame 500 includes a Category field 505, an Action field 510, and a Trigger field 515 configured according to the IEEE 802.11REVmc standard. The category field 505 and action field 510 identify the frame as an RTT Feedback frame. The RTT Feedback frame 500 also includes an RTT field 520 that includes the combined RTT. After receiving the RTT Feedback frame 500, the responder may retrieve the RTT in the RTT Feedback frame 500 and determine the range between the responder and the initiator based on the RTT. For example, the responder may determine the range by multiplying RTT/2 by the wireless signal speed between the responder and initiator (e.g., approximately equal to the speed of light). In certain aspects, the initiator may include multiple antennas in which the initiator is capable of switching between the antennas for transmission and reception. For example, if the initiator is implemented with the access terminal 220, then the multiple antennas may correspond to antennas 270-1 to 270-N. Similarly, the responder may include multiple antennas in which the responder is capable of switching between the antennas for transmission and reception. For example, if the initiator is implemented with the access point 210, then the multiple antennas may correspond to antennas 230-1 to 230-N.

In one example, the initiator and responder may exchange FTM frames using different antenna pairs (i.e., different pairs of antennas), where each antenna pair includes an antenna at the responder and an antenna at the initiator. In this example, the antenna pair may be switched for each FTM/ACK. For example, the initiator and responder may use a first antenna pair for the first FTM/ACK, switch to a second antenna pair for the second FTM/ACK, switch to a third antenna pair for the third FTM/ACK, and so forth.

It is to be appreciated that two different antenna pairs may have one antenna in common. For example, two different antenna pairs may use the same antenna at the responder while using different antennas at the initiator, or vice versa. In other cases, the antennas at both the initiator and the responder may be different.

In the above example, the antenna switching at the responder and initiator may be coordinated between the responder and the initiator so that the antenna pair used for each FTM/ACK is known by the responder and the initiator. This may be accomplished, for example, by exchanging switch coordination information between the responder and the initiator. The switch coordination information may be included in the FTM request frame or a control message communicated between the responder and the initiator.

By switching the antenna pair for each FTM/ACK, the initiator is able to compute RTTs for different antenna pairs. Each antenna pair corresponds to a different spatial channel (link) between the responder and the initiator. As a result, the initiator is able to compute RTTs for different spatial channels between the responder and the initiator. For each RTT, the corresponding spatial channel is determined by the antenna pair used for the corresponding FTM/ACK (i.e., the FTM/ACK used to compute the RTT).

Ranging accuracy depends on how accurately a direct path between the initiator and the responder is detected and estimated in time. It is easier and more reliable to estimate the direct path in a Line-of-Sight (LOS) channel than a Non-Line-of-Sight (NLOS) channel, and in a multipath-light channel than a multipath-rich channel. Thus, the quality of an RTT depends on the corresponding spatial channel with a LOS channel generally providing a higher quality RTT than a NLOS channel and a multipath-light channel generally providing a higher quality RTT than a multipath-rich channel.

Since the initiator computes RTTs for different spatial channels in the above example, the quality of the RTTs may vary. For example, some of the RTTs may correspond to LOS and/or multipath-light channels, while other RTTs may correspond to NLOS and/or multipath-rich channels. In this example, the RTTs corresponding to the LOS and/or multipath-light channels are generally of higher quality, and therefore provide for a more accurate estimation of the range between the responder and the initiator.

Computing RTTs for different spatial channels (e.g., by switching the antenna pairs for the corresponding FTM/ACKs) increases the chance of getting good RTT measurements in LOS and/or multipath-light channels. However, there is currently no mechanism for enabling the initiator to determine the quality of an RTT and to feed back that information to the responder. Such information may allow the responder to select the best antenna pair for communication with the initiator in a semi-static environment to achieve enhanced RTT performance, as discussed further below.

Embodiments of the present disclosure allow the initiator to determine the quality of RTTs and to feedback RTT quality information to the responder, as discussed further below.

In certain aspects, the RTT Feedback frame (“RTT Feedback”) discussed above is extended to include not only RTT information, but also RTT quality information. In this regard, FIG. 6 shows an exemplary format for an RTT Feedback frame 600 that includes RTT quality information according to certain aspects of the present disclosure.

In this example, the RTT Feedback frame 600 includes the Category field 602 defined in 9.4.1.11 (Action field) in 802.11REVmc_D6.0 draft, and the Public Action field 604 defined in 9.6.8.1 (Public Action frames) in 802.11REVmc_D6.0 draft.

The RTT Feedback frame 600 also includes the RTT field 606 discussed above (i.e., field 520 in FIG. 5), which includes a combined RTT for the current burst. The RTT field 606 may be 2-byte, signed, at 100 picosecond (ps) unit. Also, the RTT field 606 may cover an RTT range from −3276800 ps to 3276700 ps with a 100 ps step. This translates to a range from −491.52 m to 494.505 m, with a 0.015 m step. In this example, the field 606 is signed to support a negative range. The reason to support the negative range is that in close range the combined RTT could be negative. It is to be appreciated that the RTT field 606 is not limited to the exemplary RTT range given above, and that the RTT field 606 may have a different RTT range.

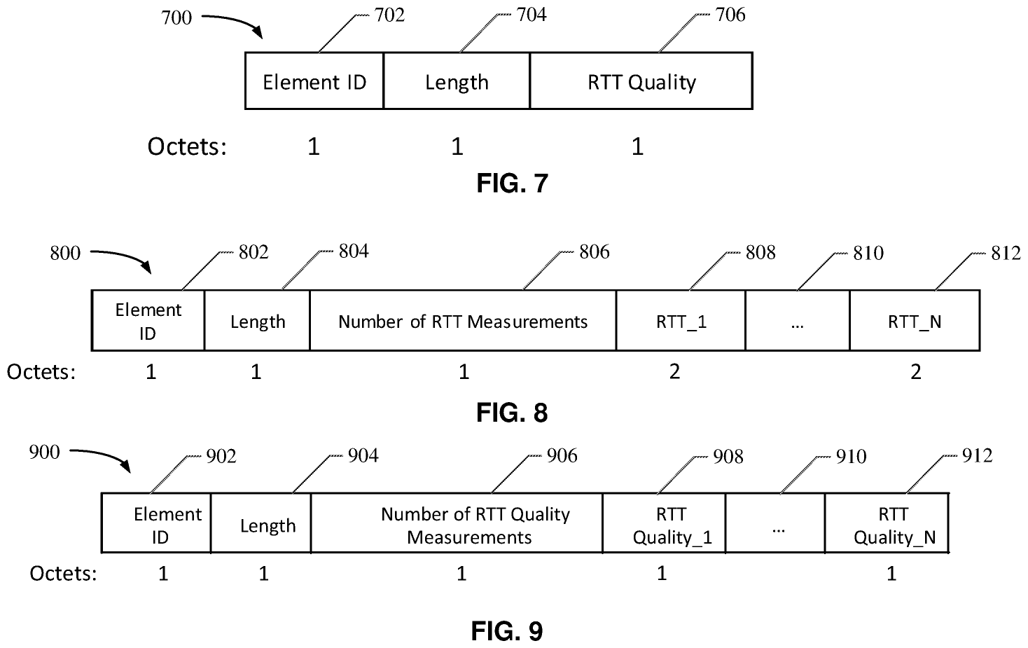

An RTT Quality field 608 is optionally present in the RTT Feedback frame 600. If present, the RTT Quality field 608 includes an RTT Quality element that is used to report the quality of the combined RTT reported in the RTT field, as discussed further below with reference to FIG. 7.

Furthermore, a Per-Packet RTT field 610 is optionally present in the RTT Feedback frame 600. If present, the Per-Packet RTT field 610 includes a Per-Packet RTT element that is used to report all of the RTT measurements obtained in the current burst, as discussed further below with reference to FIG. 8.

Still further, a Per-Packet RTT Quality field 612 is optionally present in the RTT Feedback frame 600. If present, the Per-Packet RTT Quality field 612 includes a Per-Packet RTT Quality element that is used to report the quality of each of the RTT measurements reported in the Per-Packet RTT field, as discussed further below with reference to FIG. 9.

Turning to FIG. 7, this figure shows an exemplary format 700 of the RTT Quality element 608 as was discussed above. The element format 700 includes an Element ID field 702 and a Length field 704 as defined in 9.4.2.1 (general) in 802.11REVmc_D6.0 draft. The Element ID field 702 may be used to identify the RTT Quality element 608.

The RTT Quality field 706 indicates the quality of the combined RTT reported in the RTT field. Examples of methods for determining the quality of the combined RTT are discussed further below. The quality can be indicated as a numerical rating. For example, the rating may be from 0 to 255, with a rating of 0 indicating the worst quality and a rating of 255 indicating the best quality. The quality may also be indicated as an absolute RTT error range with nanosecond units, e.g., from 0 ns to 255 ns. In this example, a 0 indicates that the RTT error is within +/−0 ns, and 255 indicates that the RTT error is within +/−255 ns. In this example, the RTT error range is a time error range with nanosecond units.

FIG. 8 shows an exemplary format 800 of the Per-Packet RTT element 610 discussed above. An Element ID field 802 and a Length field 804 are defined in 9.4.2.1 (general) in 802.11REVmc_D6.0 draft. The Element ID field 802 may be used to identify the Per-Packet RTT element 610. The Number of RTT Measurements field 806 indicates the number of RTTs reported in the Per-Packet RTT element 610. In this example, a field of 1 byte can indicate up to 255 RTTs, but is not limited to such.

The RTT_1 to RTT_N fields (i.e., RTT_1 field 808, the N-2 fields 810 in between, and RTT_N field 812) are used to report N RTTs obtained from the current burst. Each of the RTT_1 to RTT_N fields 808, 810, 812 may be 2-byte, signed, at 100 picosecond (ps) unit. Each field may cover an RTT range from −3276800 ps to 3276700 ps with a 100 ps step, which translates to a range from −491.52 m to 494.505 m, with a 0.015 m step. In this example, each field is signed to support a negative range. The reason for supporting the negative range is that in close range an RTT could be negative. In this example, each of the N RTTs may be computed from a respective FTM/ACK in the current burst.

As discussed above, the responder and initiator may switch antenna pairs for each FTM/ACK. In this example, the RTT_1 to RTT_N fields may report RTTs for different antenna pairs which correspond to different spatial channels between the initiator and the responder. Thus, in this example, the RTT_1 to RTT_N fields may report RTTs for different spatial channels to the responder. Since antenna switching is coordinated between the initial and the responder, the responder may determine the spatial channel for each reported RTT. For example, the responder and the initiator may cycle through multiple spatial channels is a particular order, and the RTT_1 to RTT_N fields may report the corresponding RTTs in the same order.

FIG. 9 shows an exemplary format 900 of the Per-Packet RTT Quality element 612 discussed above. The Element ID field 902 and Length field 904 are defined in 9.4.2.1 (general) in 802.11REVmc_D6.0 draft. The Element ID field 902 may be used to identify the Per-Packet RTT Quality element 612.

The Number of RTT Quality Measurements field 906 indicates the number of RTT quality measurements in the Per-Packet RTT Quality element 612. In this example, a field of 1 byte can indicate up to 255 RTT quality measurements.

The RTT Quality_1 908 to RTT Quality_N 912 fields (including intervening N-2 numbers of fields 910) are used to report the quality of the N RTTs reported in the Per-Packet RTT element 800. Each RTT Quality field reports the quality of a respective one of the RTTs in the Per-Packet RTT element 610. In one example, the RTT Quality_1 field 908 reports the quality of the RTT in the RTT_1 field (e.g., 808), the RTT Quality_2 field reports the quality of the RTT in the RTT_2 field (e.g., RTT_2 within the range 810), and so forth.

Examples of methods for determining the quality of each RTT are discussed further below. The quality of each RTT can be indicated as a numerical rating. For example, the rating may be from 0 to 255, with a rating of 0 indicating the worst quality and a rating of 255 indicating the best quality. The quality of each RTT may also be indicated as an absolute RTT error range with nanosecond unit, e.g., from 0 ns to 255 ns. In this example, a 0 indicates that the RTT error is within +/−0 ns, and 255 indicates that the RTT error is within +/−255 ns.

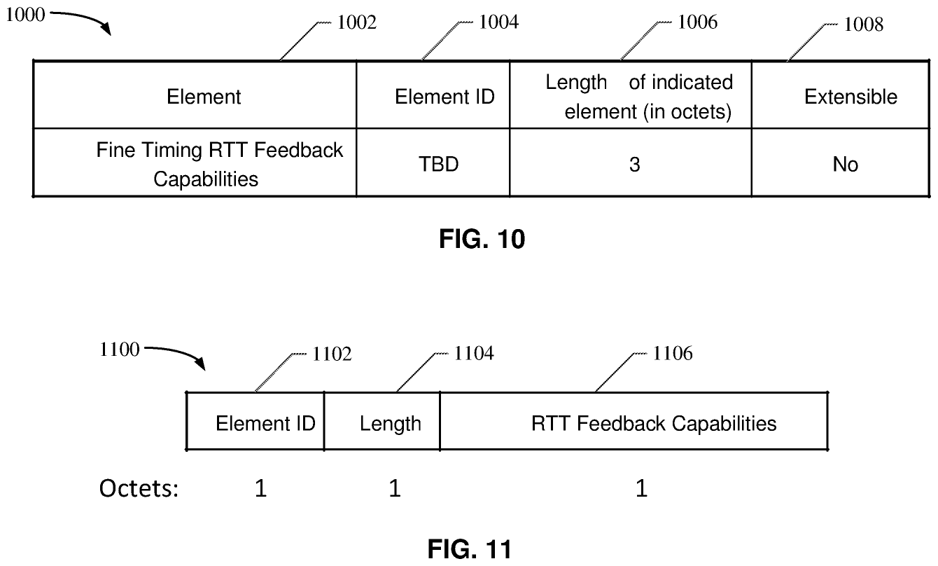

In certain aspects, the initiator may transmit an RTT Feedback Capabilities element to the responder to report the capabilities of the initiator in reporting RTT and RTT quality information. The initiator may append the RTT Feedback Capabilities element to the FTM request (FTMR) frame as was discussed previously. FIG. 10 shows at 1000 an example of the characteristics of an RTT Feedback Capabilities in tabular format that indicates those fields or information that may be included in the RTT Feedback Capabilities element that may be appended to the FTMR. In particular, the element format may include a Fine Timing RTT Feedback Capabilities element 1002, an Element ID 1004, a length indicator 1006 that indicates the length of the element in octets, and a field 1008 that indicates whether the element is extensible.

FIG. 11 shows an exemplary format 1100 for an RTT Feedback Capabilities element configured according to the fields that may be included as was shown by FIG. 10. In this example, an Element ID 1102 identifies the RTT Feedback Capabilities element 1100 and may be assigned any number to identify the RTT Feedback Capabilities element that is not already used to identify another element (i.e., any unused number may be used to identify the RTT Feedback Capabilities element). Further, a Length field 1104 may be set to 1 octet, which indicates the bit length of the actual RTT Feedback Capabilities element, shown at 1106. In the example of FIG. 11, the RTT Feedback Capabilities field 1106 has a length of one octet (i.e., 8 bits), where the bits may be referred to as a range from Bit 0 to Bit 7. In an example, Bit 0 may be set to 1 if the initiator is capable of sending the RTT Feedback frame at the end of an RTT burst and is set to 0 otherwise. Bit 1 may be set to 1 if the initiator is capable of generating the RTT Quality field in the RTT Feedback frame and is set to 0 otherwise. Bit 2 is set to 1 if the initiator is capable of generating the Per-Packet RTT field in the RTT Feedback frame and is set to 0 otherwise. Bit 3 is set to 1 if the initiator is capable of generating the Per-Packet RTT Quality field in the RTT Feedback frame and is set to 0 otherwise. Bits 4-7 are reserved for future information or for user customized information. Thus, it will be appreciated that the values of the bits in field 1106 indicate what types of information the initiator is capable of sending the responder in the RTT Feedback frame.

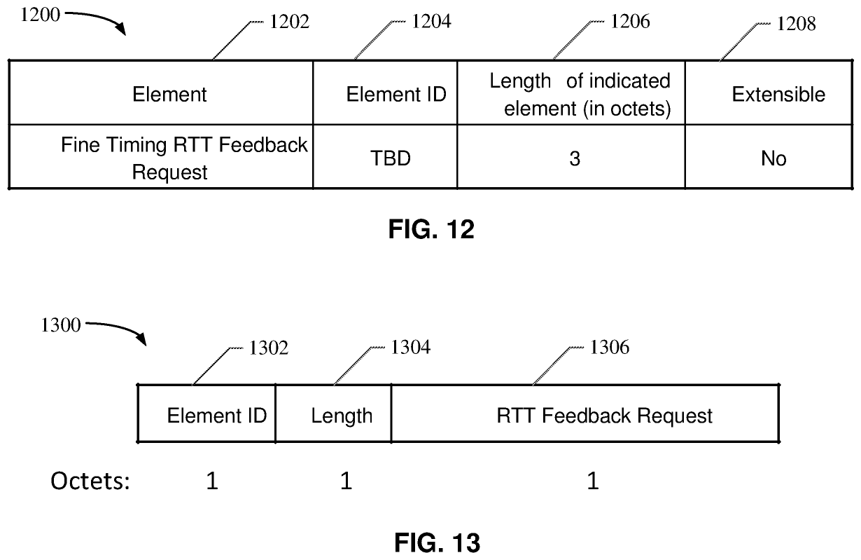

In certain aspects, the responder may transmit an RTT Feedback Request element to the initiator to request that the initiator transmit the RTT Feedback frame to the responder at the end of a burst with requested fields. The responder may append the RTT Feedback request element to the first FTM frame (e.g., “FTM_1” as may be seen in FIG. 4). FIG. 12 shows an exemplary listing of information 1200 shown in tabular form that may be contained in an RTT Feedback Request element. As shown, the RTT Feedback Request element may include the Fine Timing RTT Feedback Request 1202, an Element ID 1204 indicating the identification of the element, a length indicator in octets 1206, and whether the element is extensible 1208.

FIG. 13 shows an exemplary format for a particularly configured RTT Feedback Request element 1300. In this example, the Element ID 1302 identifies the RTT Feedback Request element and may be assigned any number to identify the RTT Feedback Request element that is not already used to identify another element. The Length field 1304 indicates the length of the RTT Feedback Request field 1306, which is set to 1 in this example.

The RTT Feedback Request field 1306 has 1 octet or 8 bits referred to as Bit 0 to Bit 7. In this example, Bit 0 is set to 1 if the responder is requesting the initiator to send the RTT Feedback frame at the end of an RTT burst and is set to 0 otherwise. Bit 1 is set to 1 if the responder is requesting the initiator to include the RTT Quality field in the RTT Feedback frame and is set to 0 otherwise. Bit 2 is set to 1 if the responder is requesting the initiator to include the Per-Packet RTT field in the RTT Feedback frame and is set to 0 otherwise. Bit 3 is set to 1 if the responder is requesting the initiator to include the Per-Packet RTT Quality field in the RTT Feedback frame and is set to 0 otherwise. Bits 4-7 are reserved.

In certain aspects, the responder reads the RTT Feedback Capabilities element (e.g., 1300) from the initiator before sending the RTT Feedback Request element to the initiator in order to determine what fields the initiator is capable of sending in the RTT Feedback frame. In these aspects, the responder refrains from requesting a field that the initiator is not capable of sending in the RTT Feedback frame according to the RTT Feedback Capabilities element. For example, if the RTT Feedback Capabilities element indicates that the initiator is not capable of sending the Per-Packet RTT field, then the responder does not bother requesting the Per-Packet RTT field in the RTT Feedback Request element. After receiving the RTT Feedback Request element from the responder, the initiator includes the requested fields in the RTT Feedback frame.

In other aspects, the responder may not be able to read the RTT Feedback Capabilities element before sending the RTT Feedback Request element or may not receive the RTT Feedback Capabilities element. In these aspects, the responder may send the RTT Feedback Request element requesting that certain fields be included in the RTT Feedback frame without knowing the capabilities of the initiator beforehand. In these aspects, the initiator may include requested fields in the RTT Feedback frame that the initiator is capable of providing and omit requested fields that the initiator is not capable of providing. Further in these aspects, if a requested field is missing from the RTT Feedback frame, then the responder may determine that the initiator is not capable of providing the missing field.

Accordingly, aspects of the present disclosure provide a protocol that provides a way for the initiator to advertise its capabilities of sending the RTT Feedback frame at the end of a burst and its capabilities of generating the optional fields in the RTT Feedback frame. Aspects of the present disclosure also provide a protocol that provides a way for the responder to request the initiator to send the RTT Feedback frame at the end of a burst with requested optional fields.

Aspects of the present disclosure further provide a protocol that provides a way for the initiator to feedback not only the combined RTT to the responder, but also RTT quality, multiple RTT measurements obtained within a burst, and the quality of each RTT measurement. The responder can make use of the information and choose the best antennas to communicate with the initiator for future FTM exchanges and/or non-FTM exchanges, especially for a semi-static system.

For example, for the case where the initiator includes the Per-Packet RTT field and Per-Packet RTT Quality field in the RTT Feedback frame, each RTT in the Per-Packet RTT field and corresponding RTT quality in the Per-Packet RTT Quality field may correspond to a respective one of multiple spatial channels between the initiator and the responder. Each spatial channel may correspond to a respective antenna pair, where one of the antennas in the pair is located at the initiator and the other one of the antennas in the pair is located at the responder. In this example, the responder may select the spatial channel (and hence antenna pair) corresponding to the RTT with the highest quality. The responder may then select the antenna at the responder corresponding to the selected antenna pair and use the selected antenna to communicate with the initiator for future FTM exchanges and/or non-FTM exchanges. For example, the responder may generate a communication signal (e.g., FTM or non-FTM signal), and transmit the communication signal to the initiator using the selected antenna. The responder may also use the selected antenna to receive a communication signal (e.g., ACK or another signal) from the initiator.

Similarly, the initiator may select the spatial channel (and hence antenna pair) corresponding to the RTT with the highest quality. The initiator may then select the antenna at the initiator corresponding to the selected antenna pair and use the selected antenna to communicate with the responder for future FTM exchanges and/or non-FTM exchanges. For example, the initiator may generate a communication signal, and transmit the communication signal to the responder using the selected antenna. The initiator may also use the selected antenna to receive a communication signal from the responder.

The responder may also make use of the RTT quality information in determining the range between the responder and the initiator. For example, the responder may select the RTT with the highest quality and use the selected RTT to compute the range. The responder may use the range, for example, to estimate the location of the initiator. For example, when the initiator is within a building, the responder may use the range and information on the layout of the building to estimate the location of the initiator within the building.

For the example in which the quality of an RTT is given as a numerical rating (e.g., from 0 to 255), the highest quality may correspond to the quality with the highest rating. For the example in which the quality of an RTT is given as an error range (e.g., 0 ns to 255 ns), the highest quality may correspond to the quality with the smallest error range.

In certain aspects, for the case where the initiator determines multiple RTTs and a quality for each RTT, the initiator may combine the RTTs by selecting the RTT with the highest quality and reporting the selected RTT in the RTT field of the RTT Feedback frame. In this example, the quality of the selected RTT may be reported in the RTT Quality field of the RTT Feedback frame. In another example, the initiator may combine the RTTs by selecting the minimum RTT and reporting the minimum RTT in the RTT field of the RTT Feedback frame. In this example, the quality of the minimum RTT may be reported in the RTT Quality field of the RTT Feedback frame. In yet another example, the initiator may combine the RTTs by computing an average of the RTTs and reporting the average RTT in the RTT field of the RTT Feedback frame. In this example, the average quality of the RTTs may be reported in the RTT Quality field of the RTT Feedback frame. It is to be appreciated that the present disclosure is not limited to the above examples, and that the combined RTT and the quality of the combined RTT may be determined using other methods.

In certain aspects, the quality of an RTT may be computed based on power measurements of the corresponding FTM frame performed at the initiator. In this regard, the initiator may measure the power of a received FTM frame at a plurality of sampling times to obtain a plurality of power samples and determine the quality of the corresponding RTT based on the power samples, as discussed further below.

In one example, the initiator may determine the quality of an RTT as follows. The initiator may measure the power of the corresponding received FTM frame at a plurality of sampling times to obtain a plurality of power samples, determine a first peak power sample in the plurality of power samples that is greater than a detection threshold, and determine the quality based on the first peak power over the total measured power.

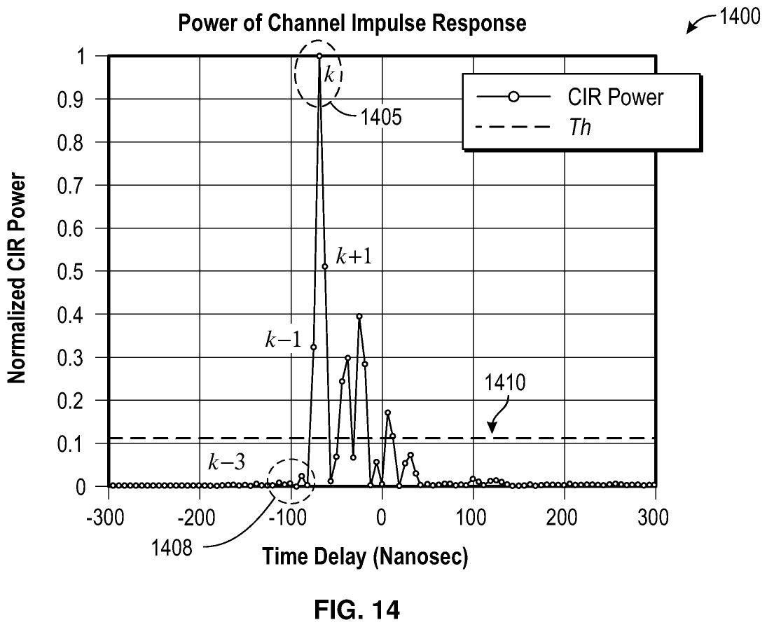

An example of this method is illustrated in FIG. 14, which shows an exemplary plot 1400 of normalized power of channel impulse response versus time delay. The channel in this example is measured in an OTA field test. The power is sampled at N sampling times to generate N power samples represented as P(n), n=1, 2, . . . , N.

In this example, the initiator may first determine the detection threshold that will be used to detect the first peak power sample. To do this, the initiator detects the strongest power sample, which is the power sample P(k) at sample time k in the example shown in FIG. 14. Power sample P(k) is indicated by reference number 1405 in FIG. 14. The initiator may then scale the strongest power sample P(k) by a scaling factor α to obtain the detection threshold Th. Thus, in this example, the detection threshold is defined as:

Th=αP(k).

The scaling factor α is between 0 and 1. For example, the scaling α may be equal to 0.1. The threshold helps prevent a weak power sample (e.g., sample at k−3) from being detected as the first peak power sample. The weak power sample P(k−3) is indicated by reference number 1408 in FIG. 14.

After determining the threshold Th, the initiator determines the first power sample that exceeds the detection threshold Th 1410, which is at sample k−1. In this example, the first peak power sample that exceeds the threshold 1410 will be power sample P(k). Here the first sample peak can be identified in a search from time delay sample k−1 to k+1 to detect the first peak, which is P(k). In this example, the first peak power sample P(k) coincides with the strongest power sample P(k), which may be indicative of a strong direct signal path between the initiator and the responder. However, it is to be appreciated that this need not be the case. For example, the strongest power may correspond to a later peak in the time delay samples (e.g., in a multipath channel).

In this example, the quality of the corresponding RTT may be determined based on the power percentage or ratio of the first peak power compared to the total power of the channel as follows:

$${R}_{firstPeak} = \frac{P ( k )}{{\sum }_{n = 1}^{N} P ( n )}$$

where R_{firstPeak} is a ratio of the first peak power over the total power of the channel. In this example, the total power is computed by summing all N power samples P(1) to P(N).

A high R_{firstPeak} indicates that the channel is closer to LOS. Thus, in this case, a high rating (or a small error range) may be used to reflect a high RTT quality. Conversely, a low R_{firstPeak} indicates that the channel is closer to NLOS. Thus, in this case, a low rating (or a large error range) may be used to reflect a low RTT quality. In certain aspects, the initiator may store a look-up-table (LUT) in memory, in which the LUT maps different values for R_{firstPeak} to respective ratings or error ranges. In this example, after computing R_{firstPeak}, the initiator may use the LUT to convert the R_{firstPeak} to the RTT quality.

In another embodiment, the initiator may determine a first group of power samples centered around the first peak power sample. The first group of power samples includes the first peak power sample and power samples located within +/−M of the first peak power sample. Thus, M defines the size of the first group of power samples. In this example, the first peak power sample may be determined using the method discussed above with reference to FIG. 14. The value of M may be determined based on the filter response of the receiver at the initiator. For example, for a wider filter response, M may be larger. For a narrower filter reference, M may be smaller.

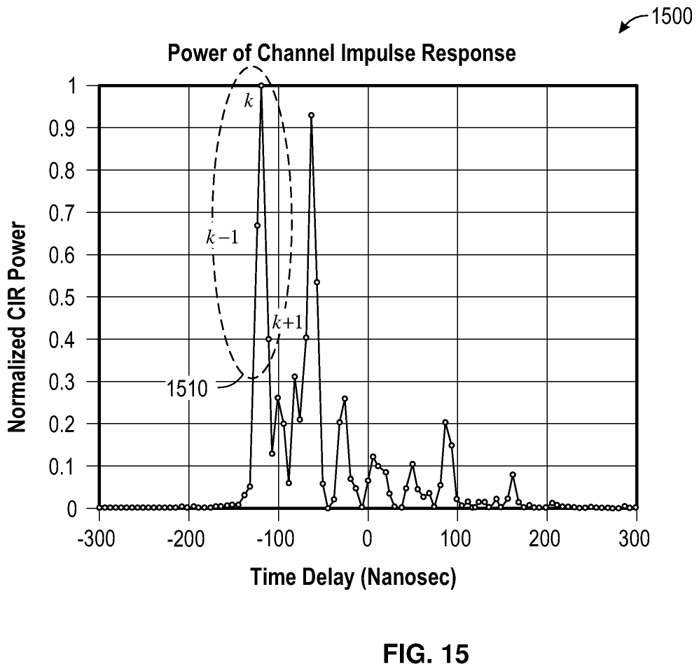

FIG. 15 shows a plot 1500 showing an example of a first group of power samples around the first peak power sample. The first group is indicated by reference number 1510 in FIG. 15. In this example, the first peak power sample P(k) is at sample k, and M equals one. Thus, in this example, the first group includes power samples P(k−1), P(k) and P(k+1).

In this example, the quality of the corresponding RTT may be determined based on the power percentage or ratio of the first group compared to the total power of the channel as follows:

$${R}_{firstGroupPeaks} = \frac{{\sum }_{m = k - M}^{k + M} P ( m )}{{\sum }_{n = 1}^{N} P ( n )}$$

where R_{firstGroupPeak} is a ratio of the power of the first group over the total power of the channel. In this example, the power of the first group is computed by summing the power samples in the first group, and total power is computed by summing all N power samples P(1) to P(N).

A high R_{firstGroupPeak} indicates that the channel is closer to LOS. Thus, in this case, a high rating (or a small error range) may be used to reflect a high RTT quality. Conversely, a low R_{firstGroupPeak} indicates that the channel is closer to NLOS. Thus, in this case, a low rating (or a large error range) may be used to reflect a low RTT quality. In certain aspects, the initiator may store a look-up-table (LUT) in memory, in which the LUT maps different values for R_{firstGroupPeak} to respective ratings or error ranges. In this example, after computing R_{firstGroupPeak}, the initiator may use the LUT to convert the R_{firstGroupPeak} to the RTT quality.

In another embodiment, the initiator may determine the quality of an RTT as follows. The initiator may measure the power of the corresponding received FTM frame at a plurality of sampling times to obtain a plurality of power samples, determine a first power sample in the plurality of power samples that exceeds the detection threshold, determine a last power sample in the plurality of power samples that exceeds the detection threshold, determine a delay spread between the first power sample and the last power sample, and determine the quality of the RTT based on the delay spread.

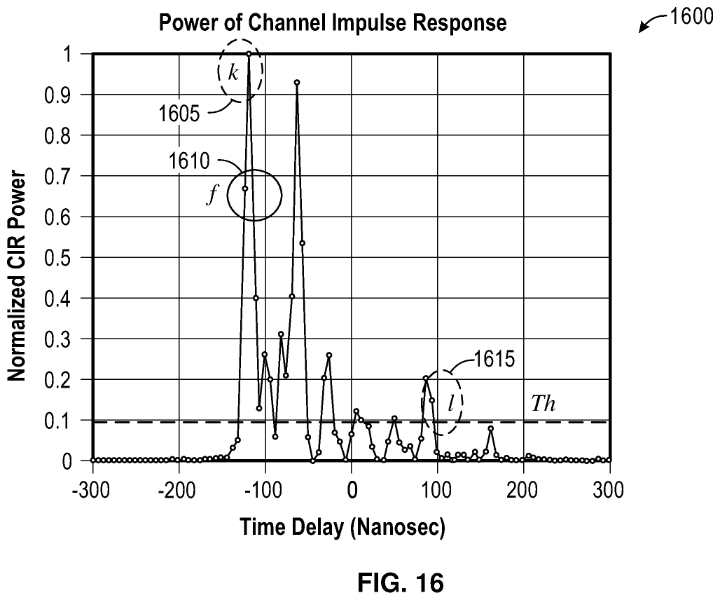

An example of this method is illustrated in FIG. 16, which shows an exemplary plot 1600 of normalized power of channel impulse response versus time delay. In this example, the initiator may first determine the detection threshold Th that will be used to detect the first power sample. To do this, the initiator detects the strongest power sample, which is the power sample P(k) at sample time k in the example shown in FIG. 16. Power sample P(k) is indicated by reference number 1605 in FIG. 16. The initiator may then scale the strongest power sample P(k) by the scaling factor α to obtain the detection threshold. The scaling factor α is between 0 and 1. For example, the scaling factor α may be equal to 0.1.

After determining the detection threshold, the initiator detects the first power sample that exceeds the threshold and the last power sample that exceeds the threshold. In the example in FIG. 16, the first power sample is at sample f, and the last power sample is at sample l. The first power sample is indicated by reference 1610 and the last power sample is indicated by reference 1615 in FIG. 16. The initiator then determines the channel delay spread as follows:

D_{spread}=l−f

where D_{spread} is the delay spread between the first power sample and the last power sample, the first power sample is at sample f and the last power sample is at sample l.

A small D_{spread} indicates that the channel is multipath-light. Thus, in this case, a high rating (or a small error range) may be used to reflect a high RTT quality. Conversely, a large D_{spread} indicates that the channel is multipath-rich. Thus, in this case, a low rating (or a large error range) may be used to reflect a low RTT quality. In certain aspects, the initiator may store a look-up-table (LUT) in memory, in which the LUT maps different values for D_{spread} to respective ratings or error ranges. In this example, after computing D_{spread}, the initiator may use the LUT to convert the D_{spread} to the RTT quality.

In another example, the initiator may compute a root mean square delay spread (RMS delay spread) and determine the RTT quality based on the RMS delay spread. The RMS delay spread may be computed as follows:

$${D}_{RMS} = \frac{{\sum }_{n = f}^{l} ( n - f ) P ( n )}{{\sum }_{n = f}^{l} P ( n )}$$

where D_{RMS} is the RMS delay spread. In this example, the numerator is a weighted sum of the power samples from the first sample f to the last sample l, in which each power sample is weighted by its delay from the first sample f. The denominator is the total power over the delay spread. In this example, D_{RMS} is larger when more power is distributed farther away from the first sample, which may be indicative of a multipath-rich channel.

A small D_{RMS} indicates that the channel is multipath-light. Thus, in this case, a high rating (or a small error range) may be used to reflect a high RTT quality. Conversely, a large D_{RMS} indicates that the channel is multipath-rich. Thus, in this case, a low rating (or a large error range) may be used to reflect a low RTT quality. In certain aspects, the initiator may store a look-up-table (LUT) in memory, in which the LUT maps different values for D_{RMS} to respective ratings or error ranges. In this example, after computing D_{RMS}, the initiator may use the LUT to convert the D_{RMS} to the RTT quality.

Other factors may also be used to determine RTT quality. For example, the initiator may determine RTT quality by measuring the RSSI of the corresponding FTM frame received at the initiator and determining the RTT quality based on the RSSI. In the example, a high RSSI may indicate that the initiator and the responder are close to each other and/or indicate a LOS channel between the initiator and the responder. In this case, the RTT quality may be high. Conversely, a low RSSI may indicate that the initiator and the responder are far apart and/or indicate a NLOS channel between the initiator and the responder. In this case, the RTT quality may be low.

In another example, the initiator may determine RTT quality by measuring the SNR of the corresponding FTM frame received at the initiator and determining the RTT quality based on the SNR. A high SNR indicates that the signal is stronger than noise, which results in a more accurate RTT measurement. In this case, the RTT quality may be high.

In another example, the initiator may determine RTT quality by measuring the noise power level and determining the RTT quality based on the noise power level. A high noise power level may result in more errors in the RTT measurement. In this case, the RTT quality may be low.

In another example, the initiator may determine RTT quality by determining the bandwidth of the corresponding FTM frame and determining the RTT quality based on the bandwidth. A higher bandwidth indicates that more channel information is available to measure RTT, which results in a more accurate RTT measurement. In this case, the RTT quality may be high.

In another example, the initiator may determine RTT quality by determining a type of the corresponding FTM frame and determining the RTT quality based on the type of the FTM frame. For example, different types of FTM frames may have different numbers of tones in the frequency domain. In this example, an FTM frame type with a larger number of tones in the frequency domain provides more channel information for measuring RTT. Thus, in this example, the RTT quality for an FTM frame type with a larger number of tones may be higher than an FTM frame type with a smaller number of tones.

It is to be appreciated that RTT quality may be determined based on two or more of the factors discussed above. For example, two or more of R_{firstPeak}, R_{firstGroupPeak}, D_{spread}, D_{RMS}, RSSI, SNR, power noise level, bandwidth and FTM frame type may be combined to jointly determine RTT quality. For example, the initiator may use one or more factors (e.g., R_{firstPeak}, R_{firstGroupPeak}, D_{spread} and/or D_{RMS}) to determine whether a channel is LOS, NLOS, multipath-light and/or multipath-rich and use this information in combination with one or more other factors (e.g., bandwidth or FTM frame type) to determine RTT quality. For example, if two FTM frames have similar channels but different bandwidths, then the initiator may determine a higher RTT quality for the FTM frame with the higher bandwidth. In another example, if two FTM frames have the same bandwidth but one of the frames is received on a LOS channel and the other is received on a NLOS channel, then the initiator may determine a higher RTT quality for the FTM frame with the LOS channel.

In the present disclosure, a statement or recitation that a quality is determined based on a factor does not necessarily require that the quality be determined based only on that factor, and therefore does not exclude the possibility that the quality may also be determined based on one or more additional factors.

As discussed above, the initiator may use R_{firstPeak}, R_{firstGroupPeak}, D_{spread} and/or D_{RMS} to estimate the channel between the initiator and the responder. For example, a high R_{firstPeak} or R_{firstGroupPeak} may be indicative of a LOS channel while a low R_{firstPeak} or R_{firstGroupPeak} may be indicative of a NLOS channel. In another example, a high D_{spread} or D_{RMS} may be indicative of a multipath-rich channel while a low D_{spread} or D_{RMS} may be indicative of a multipath-light channel.

In certain aspects, the initiator may use one or more detection thresholds to detect the arrival time of an FTM frame. The initiator may use the detected arrival time of the FTM frame to determine the first power sample used in the D_{spread} or D_{RMS} computation discussed above. The initiator may also use the detected arrival time of the FTM frame to determine time t2 used to determine the corresponding RTT, as discussed further below. As discussed above, the initiator may determine RTT based on a FTM frame using times t1, t2, t3 and t4, where time t1 is the time the FTM frame is transmitted from the responder, t2 is the time the FTM frame is received at the initiator, t3 is the time the acknowledgement of the FTM frame is transmitted from the initiator, and time t4 is the time the acknowledgement of the FTM frame is received at the responder.

The initiator may determine one or more detection thresholds according to various aspects of the present disclose. For example, in certain aspects, the initiator may determine a detection threshold as follows:

Th_{fac}^{peak}=αP(k)

where k is the index of the strongest power sample for the received FTM frame, a is a scaling factor between 0 and 1 (e.g., α=0.1), and Th_{fac}^{peak} represented the detection threshold. Thus, in these aspects, the detection threshold is determined by multiplying the strongest power sample by the scaling factor α.

In certain aspects, the initiator may determine a detection threshold as follows:

Th_{fac}^{noise}=βPₙ

where Pₙ is the noise power level for the received FTM frame, β is a scaling factor (e.g., β=40, and Th_{fac}^{noise} represents the detection threshold. Thus, in these aspects, the detection threshold is determined by multiplying the noise power level by the scaling factor β.

In certain aspects, the initiator may determine a detection threshold as follows:

Th_{fac}^{RSSI}=γ10^{C-RSSI/10}P(k)

where RSSI is received signal strength indicator for the received FTM frame in dBm, C is an offset (C=−96 dBm), γ is a scaling factor (e.g., γ=2), and Th_{fac}^{RSSI} represents the detection threshold. Thus, in these aspects, the detection threshold is determined based on RSSI. The offset C may be approximately equal to a typical noise power. The power of ten is used to convert C-RSSI, which is in dBm, into a linear value.

In certain aspects, the initiator may determine a detection threshold as follows:

Th_{fac}^{SNR}=θ10^{-SNR/10}P(k)

where SNR is the signal to noise power ratio for the received FTM frame in dB, θ is a scaling factor (θ=2), and Th_{fac}^{SNR} represents the detection threshold. Thus, in these aspects, the detection threshold is determined based on SNR. The power of ten is used to convert −SNR, which is in dBm, into a linear value.

Thus, the initiator may determine one or more detection thresholds based on the strongest power sample, the noise power level, RSSI and/or SNR of the FTM frame. After determining the one or more detection thresholds, the initiator may use the one or more detection thresholds to determine the arrival time of the FTM frame.

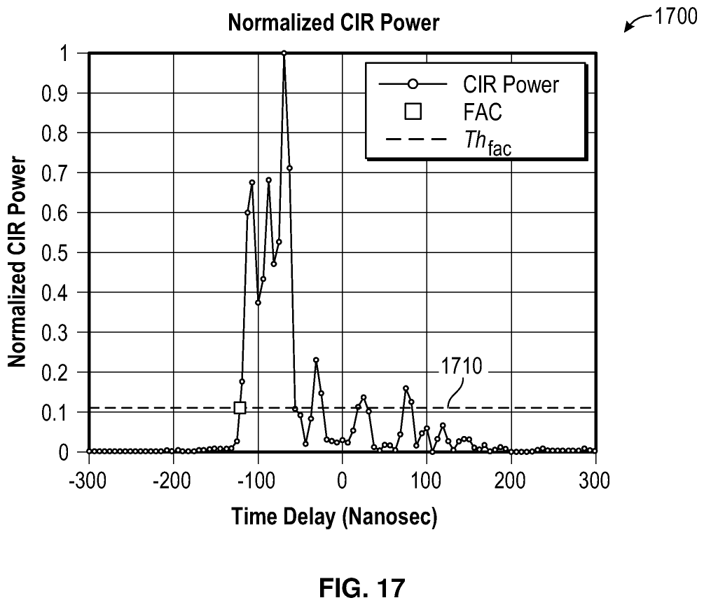

An example of this is illustrated in FIG. 17, which shows an exemplary plot 1700 of normalized power of channel impulse response versus time delay. The power of the FTM frame is sampled at N sampling times to generate N power samples represented as P(n), n=1, 2, . . . , N.

In this example, the initiator determines a first arrival detection threshold 1710 based on one or more of the detection thresholds discussed above. For example, the first arrival detection threshold 1710 may be one of the detection thresholds discussed above or a combination of two or more of the detection thresholds (e.g., an average of the one or more detection thresholds). The initiator may then determine the first arrival time of the FTM frame based on the first arrival detection threshold 1710. For example, the initiator may determine the first arrival time by detecting the first power sample that exceeds the first arrival detection threshold 1710 and determining the first arrival time based on the sample time of the first power sample. For example, the initiator may determine the first arrival time to be approximately equal to the sample time of the first power sample. Note that the first arrival detection threshold 1710 does not need to be determined before the arrival of the FTM frame. This is because the power samples for the FTM frame are stored in memory at the initiator, allowing the initiator to go back and determine when the FTM frame arrived at the initiator using the stored power samples.

In another example, the initiator may determine the first arrival time for the FTM frames based on a combination of two or more of the detection thresholds by determining a separate first arrival time using each one of the two or more detection thresholds, and then combining the first arrival times (e.g. computing an average of the first arrival times) to determine a final first arrival time.

In certain aspects, the initiator may determine the channel between the initiator and the responder for the FTM frame, and use the determined channel to determine the first arrival detection threshold 1710. For example, the initiator may determine whether a channel is LOS, NLOS, multipath-light and/or or multipath-rich based on one or more of R_{firstPeak}, R_{firstGroupPeak}, D_{spread} and D_{RMS}, and use this channel information to determine the first arrival detection threshold 1710.

For example, if the initiator determines that the channel is a NLOS channel or multipath-rich channel and the noise power level is low, then the initiator may use Th_{fac}^{noise} for the first arrival detection threshold 1710. In this case, Th_{fac}^{noise} is low and can therefore be used to detect a first arrival path that is blocked/attenuated and not trigger false detection on a noise sample.

In another example, if the initiator determines the channel is a NLOS channel or multipath-rich channel and the noise power level is high, then the initiator may use Th_{fac}^{noise} for the first arrival detection threshold 1710. In this case, Th_{fac}^{noise} is high so that the chance of a false trigger on a noise sample is reduced.

In another example, if the initiator determines that the channel is a LOS channel or multipath-light channel, then the initiator may use Th_{fac}^{noise} for the first arrival detection threshold 1710. In this case, Th_{fac}^{noise} is high and can be used to reliably detect the first arrival path whether noise power level is low or high, as the first arrival path is strong enough to be detected even using a high threshold.

In another example, the initiator may determine the first arrival time as a weighted sum of two or more first arrival times, where each of the two or more first arrival times is determined based on a respective one of the detection thresholds discussed above. In this example, each weight may be between 0 and 1. The initiator may determine the weights of the two or more first arrival times based on whether the channel is LOS/NLOS and/or multipath-rich/light. For example, the initiator may store a look-up-table (LUT) in memory mapping different channels to different sets of weights. In this example, the initiator may determine the channel based on one or more of R_{firstPeak}, R_{firstGroupPeak}, D_{spread} and D_{RMS}, and retrieve the set of weights corresponding to the determined channel. The initiator may then weigh the two or more first arrival times by the respective weights and compute the weighted sum of the two or more first arrival times to determine the final first arrival time.

Accordingly, the initiator may determine the first arrival time of the FTM frame based on a number of factors. This is represented by the following expression:

FAC_{final}=fₓ(FACₚₑₐₖ,FACₙₒᵢₛₑ,FAC_{RSSI},FAC_{SNR},R_{firstpeak},R_{firstGroupPeaks}, D_{spread},D_{RMS})

where FAC_{final} is the final first arrival time determined based on the factors, FACₚₑₐₖ is the first arrival time determined using the detection threshold Th_{fac}^{peak}, FACₙₒᵢₛₑ is the first arrival time determined using the detection threshold Th_{fac}^{noise}, FAC_{RSSI} is the first arrival time determined using the detection threshold Th_{fac}^{RSSI}, and FAC_{SNR} is the first arrival time determined using the detection threshold Th_{fac}^{SNR}. It is to be appreciated that the final first arrival time does not need to be determined based on all of the factors shown in the above expression, and may be determined based on a subset of the factors in the expression. As discussed above, the initiator may determine the channel (e.g., LOS/NLOS and/or multipath-light/multipath-rich) based on one or more of R_{firstPeak}, R_{firstGroupPeaks}, D_{spread} and D_{RMS}, and compute a weighted sum of two or more of FACₚₑₐₖ, FACₙₒᵢₛₑ, FAC_{RSSI} and FAC_{SNR} in which the weights are determined based on the determined channel. As discussed above, the weighs may be determined using a LUT that maps different channels to different sets of weights. The initiator may use the final arrival time of the FTM frame as t2 in the RTT computation, as discussed above.

The responder may detect the arrival time of the acknowledgement of the FTM frame using similar techniques discussed above for detecting the arrival time of the FTM frame. For example, the responder may determine one or more detection thresholds based on the strongest power sample, the noise power level, RSSI and/or SNR of the acknowledgement received at the responder. The responder may then use the one or more detection thresholds to determine the arrival time of the acknowledgement of the FTM frame. Thus, the above description of the detection of the arrival time of the FTM frame also applies to the detection of the arrival time of the acknowledgement at the responder. The responder may use the detected arrival time of the acknowledgement to determine time t4 used to determine the corresponding RTT, and report time t4 to the initiator in the next FTM frame. As discussed above, the initiator may use time t4 along with times t1, t2 and t3 to determine the corresponding RTT.

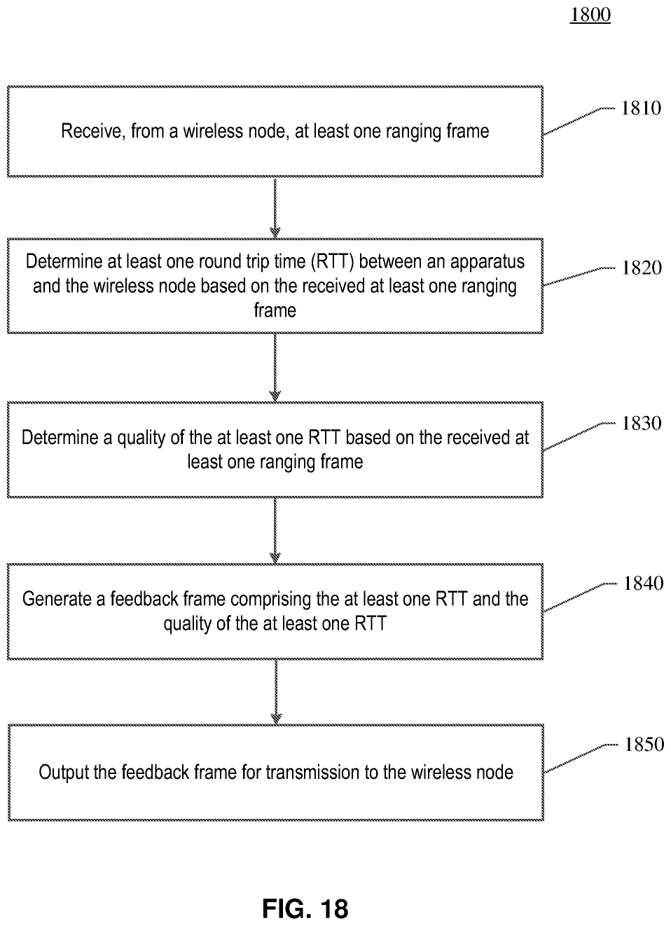

FIG. 18 shows an exemplary method 1800 for wireless communications according to certain aspects of the present disclosure. Method 1800 includes receiving, at an apparatus, at least one ranging frame, such as a timing measurement frame FTM or an NDP frame in the case of IEEE 802.11az, from a wireless device or node as shown in block 1802. After receiving the ranging frame, at least one round trip time (RTT) between the apparatus and the wireless node is determined based on the received at least one ranging frame as shown in block 1820. Next at block 1830, a quality of the at least one RTT is determined based on the received at least one ranging frame.

Method 1800 further includes generating a feedback frame including the at least one RTT and the quality of the at least one RTT as shown at block 1840. An example of this feedback frame includes the RTT Feedback frame 600 shown in FIG. 6 as discussed earlier, or in or with Location Measurement Report (LMR) frames as used in IEEE 802.11az, which will be described later in connection with FIGS. 21 and 22. At block 1850, the feedback frame is output for transmission to the wireless node.

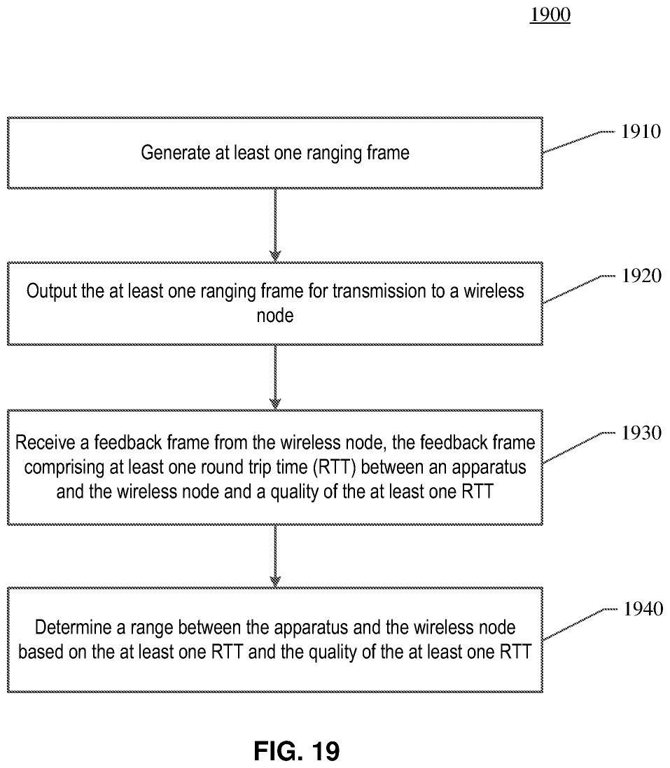

FIG. 19 shows another exemplary method 1900 for wireless communications according to certain aspects of the present disclosure. Method 1900 includes generating at least one ranging frame, which may be an NDP or FTMR frame, for example, as shown at block 1910. Next, the generated ranging frame is output for transmission to a wireless node as shown at block 1920.

At block 1930, a feedback frame, such as RTT Feedback frame 600, is received from the wireless node. In an aspect, the feedback frame includes at least one round trip time (RTT) between the apparatus transmitting the at least one ranging frame and the wireless node, as well as a quality of the at least one RTT. After receiving the feedback frame, a range between the apparatus and the wireless node may be determined based on the at least one RTT and the quality of the at least one RTT as shown in block 1940. The range determination processes of block 1940 may include various processes such as by multiplying RTT/2 by the wireless signal speed (e.g., approximately light speed) between the apparatus and wireless node, as one example. Additionally, the processes of block 1940 may include compensation for the RTT error determined according to the various processes disclosed earlier in connection with FIGS. 14-17.

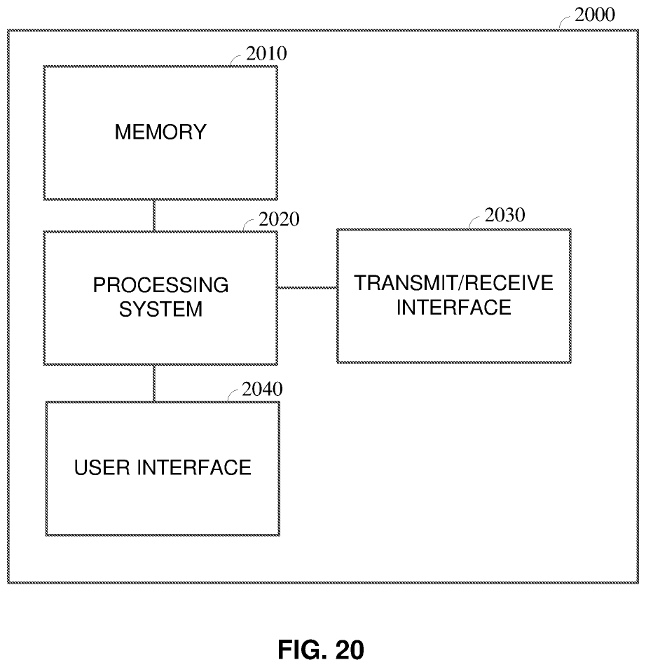

FIG. 20 illustrates an exemplary apparatus or device 2000 according to certain aspects of the present disclosure. The device 2000 may be configured to operate in a wireless device (e.g., access point 210 or access terminal 220) and to perform one or more of the operations described herein. The device 2000 may act as an initiator or a responder.

The device 2000 includes a processing system 2020, and a memory 2010 coupled to the processing system 2020. The memory 2010 may store instructions that, when executed by the processing system 2020, cause the processing system 2020 to perform one or more of the operations described herein. Exemplary implementations of the processing system 2020 are provided below. The device 2000 also comprises a transmit/receive interface 2030 coupled to the processing system 2020. The transmit/receive interface 2030 may be configured to interface the processing system 2020 to a radio frequency (RF) front end (e.g., transceivers 226-1 to 226-N or 226-1 to 266-N). The interface 2030 may also be configured to receive, from another wireless node (e.g., an access terminal 120 or an access point 110), at least one ranging frame, which may be a timing frame configured according to IEEE 802.11REVmc protocol or an NDP frame configured according to IEEE 802.11az protocol, as two examples. Additionally, interface 2030 may be configured to generate at least one ranging frame for transmission by device 2000 to another wireless node.

In certain aspects, the processing system 2020 may include one or more of the following: a transmit data processor (e.g., transmit data processor 218 or 260), a frame builder (e.g., frame builder 222 or 262), a transmit processor (e.g., transmit processor 224 or 264) and/or a controller (e.g., controller 234 or 274) for performing one or more of the operations described herein.

In the case of an access terminal 220, the device 2000 may include a user interface 2040 coupled to the processing system 2020. The user interface 2040 may be configured to receive data from a user (e.g., via keypad, mouse, joystick, touchscreen, audio devices, cameras, etc.) and provide the data to the processing system 2020. The user interface 2040 may also be configured to output data from the processing system 2020 to the user (e.g., via a display, speaker, Bluetooth® connected device, etc.). In this case, the data may undergo additional processing before being output to the user. In the case of an access point 210, the user interface 2040 may be omitted.

In other examples of various apparatus that may be utilized for performing one or more of the operations described herein, it is noted that means for receiving, from a wireless node, at least one timing measurement or ranging frame may include at least one of the receive processor 242 or 282, the transceivers 226-1 to 226-N or 266-1 to 266-N, or the transmit/receive interface 2030. Examples of means for determining at least one round trip time (RTT) between an apparatus and the wireless node based on the received at least one timing measurement or ranging frame may include at least one of the controller 234 or 274, or the processing system 2020. Examples of means for determining a quality of the at least one RTT based on the received at least one timing measurement or ranging frame may include at least one of the controller 234 or 274, or the processing system 2020. Examples of means for generating a feedback frame comprising the at least one RTT and the quality of the at least one RTT may include at least one of the controller 234 or 274, or the processing system 2020. Examples of means for outputting the feedback frame for transmission to the wireless node may include at least one of the transmit processor 224 or 264, the transceivers 226-1 to 226-N or 266-1 to 266-N, or the transmit/receive interface 2030. Examples of, for each one of the received plurality of timing measurement or ranging frames, means for determining a respective RTT based on the one of the received plurality of timing measurement or ranging frames may include at least one of the controller 234 or 274, or the processing system 2020. Examples of means for combining the determined RTTs for the plurality of timing measurement or ranging frames to obtain the combined RTT may include at least one of the controller 234 or 274, or the processing system 2020. Examples of means for determining a respective quality based on the respective one of the plurality of timing measurement or ranging frames for each one of determined RTTs may include at least one of the controller 234 or 274, or the processing system 2020. Examples of means for combining the qualities of the determined RTTs to obtain the quality of the combined RTT may include at least one of the controller 234 or 274, or the processing system 2020. Examples of means for generating an acknowledgement for each one of the received plurality of timing measurement or ranging frames may include at least one of the controller 234 or 274, or the processing system 2020. Examples of means for outputting the acknowledgement for each one of the received plurality of timing measurement or ranging frames for transmission to the wireless node may include at least one of the transmit processor 224 or 264, the transceivers 226-1 to 226-N or 266-1 to 266-N, or the transmit/receive interface 2030.

Furthermore, examples of means for generating a message indicating a capability of providing the quality of the at least one RTT may include at least one of the controller 234 or 274, or the processing system 2020. Examples of means for outputting the message for transmission to the wireless node may include at least one of the transmit processor 224 or 264, the transceivers 226-1 to 226-N or 266-1 to 266-N, or the transmit/receive interface 2030. Examples of means for determining each one of the plurality of RTTs based on a respective one of the received plurality of timing measurement or ranging frames may include at least one of the controller 234 or 274, or the processing system 2020. Examples of means for determining the quality of each one of the plurality of RTTs based on the respective one of the received plurality of timing measurement or ranging frames may include at least one of the controller 234 or 274, or the processing system 2020. Examples of means for generating an acknowledgement for each one of the received plurality of timing measurement or ranging frames may include at least one of the controller 234 or 274, or the processing system 2020. Examples of means for outputting the acknowledgement for each one of the received plurality of timing measurement or ranging frames for transmission to the wireless node may include at least one of the transmit processor 224 or 264, the transceivers 226-1 to 226-N or 266-1 to 266-N, or the transmit/receive interface 2030.

Yet further, examples of means for generating a message indicating a capability of providing the plurality of RTTs and the quality of each one of the plurality of RTTs may include at least one of the controller 234 or 274, or the processing system 2020. Examples of means for outputting the message for transmission to the wireless node may include at least one of the transmit processor 224 or 264, the transceivers 226-1 to 226-N or 266-1 to 266-N, or the transmit/receive interface 2030. Examples of means for measuring power of the received at least one timing measurement or ranging frame at a plurality of sample times to obtain a plurality of power samples may include at least one of the receive processor 242 or 282, the controller 234 or 274, or the processing system 2020. Examples of means for determining a first peak power sample in the plurality of power samples that is greater than a threshold may include at least one of the controller 234 or 274, or the processing system 2020. Examples of means for determining the quality of the at least one RTT based on the first peak power sample may include at least one of the controller 234 or 274, or the processing system 2020. Examples of means for summing the plurality of power samples to obtain a total power may include at least one of the controller 234 or 274, or the processing system 2020.

Examples of means for determining the quality of the at least one RTT based on a ratio of the first peak power sample over the total power may include at least one of the controller 234 or 274, or the processing system 2020. Examples of means for determining a strongest peak power sample in the plurality of power samples may include at least one of the controller 234 or 274, or the processing system 2020. Examples of means for multiplying the strongest peak power sample by a scaling factor to obtain the threshold may include at least one of the controller 234 or 274, or the processing system 2020. Examples of means for determining a noise power may include at least one of the receive processor 242 or 282, the controller 234 or 274, or the processing system 2020. Examples of means for multiplying the noise power by a scaling factor to obtain the threshold may include at least one of the controller 234 or 274, or the processing system 2020. Examples of means for determining the threshold based on at least one of a receive signal strength indicator (RSSI) of the received at least one timing measurement or ranging frame or a signal-to-noise ratio (SNR) of the received at least one timing measurement or ranging frame may include at least one of the controller 234 or 274, or the processing system 2020. Examples of means for determining a group of power samples in the plurality of power samples that are located within a time interval of the first peak power sample in time may include at least one of the controller 234 or 274, or the processing system 2020. Examples of means for determining the quality of the at least one RTT based also on the group of power samples may include at least one of the controller 234 or 274, or the processing system 2020.

Examples of means for measuring power of the received at least one timing measurement or ranging frame at a plurality of sample times to obtain a plurality of power samples may include at least one of the receive processor 242 or 282, the controller 234 or 274, or the processing system 2020. Examples of means for determining a first one of the plurality of power samples that is greater than a threshold may include at least one of the controller 234 or 274, or the processing system 2020. Examples of means for determining a last one of the plurality of power samples that is greater than the threshold may include at least one of the controller 234 or 274, or the processing system 2020. Examples of means for determining a delay spread between the first one of the plurality of power samples and the last one of the plurality of power samples may include at least one of the controller 234 or 274, or the processing system 2020. Examples of means for determining the quality of the at least one RTT based on the determined delay spread may include at least one of the controller 234 or 274, or the processing system 2020. Examples of means for determining the quality of the at least one RTT based on at least one of a receive signal strength indicator (RSSI) of the received at least one timing measurement or ranging frame, a signal-to-noise ratio (SNR) of the received at least one timing measurement or ranging frame, a noise power of the received at least one timing measurement or ranging frame, a bandwidth of the at least one received timing measurement or ranging frame, or a type of the received at least one timing measurement or ranging frame may include at least one of the controller 234 or 274, or the processing system 2020.

Examples of means for determining an arrival time of the at least one timing measurement or ranging frame at the apparatus may include at least one of the controller 234 or 274, or the processing system 2020. Examples of means for determining the at least one RTT based on the determined arrival time may include at least one of the controller 234 or 274, or the processing system 2020. Examples of means for measuring power of the received at least one timing measurement or ranging frame at a plurality of sample times to obtain a plurality of power samples may include at least one of the receive processor 242 or 282, the controller 234 or 274, or the processing system 2020. Examples of means for determining a first one of the plurality of power samples that is greater than a threshold may include at least one of the controller 234 or 274, or the processing system 2020. Examples of means for determining the arrival time based on the sample time of the first one of the plurality of power samples may include at least one of the receive processor 242 or 282, the controller 234 or 274, or the processing system 2020. Examples of means for determining a channel between the apparatus and the wireless node based on the received at least one timing measurement or ranging frame may include at least one of the receive processor 242 or 282, the controller 234 or 274, or the processing system 2020. Examples of means for selecting one of a plurality of thresholds based on the determined channel may include at least one of the controller 234 or 274, or the processing system 2020. Examples means for using the selected one of the plurality of thresholds for the threshold may include at least one of the controller 234 or 274, or the processing system 2020. Examples of means for determining a set of weights based on the determined channel may include at least one of the controller 234 or 274, or the processing system 2020. Examples of means for determining a plurality of arrival times for the at least one timing measurement or ranging frame based on a plurality of different thresholds may include at least one of the controller 234 or 274, or the processing system 2020. Examples of means for computing a weighted sum of the plurality of arrival times, wherein each one of the plurality of arrival times is weighted by a respective weight in the set of weights may include at least one of the controller 234 or 274, or the processing system 2020.

Examples of means for generating at least one timing measurement or ranging frame may include at least one of the controller 234 or 274, or the processing system 2020. Examples of means for outputting the at least one timing measurement or ranging frame for transmission to a wireless node may include at least one of the transmit processor 224 or 264, the transceivers 226-1 to 226-N or 266-1 to 266-N, or the transmit/receive interface 2030. Examples of means for receiving a feedback frame from the wireless node may include at least one of the receive processor 242 or 282, the transceivers 226-1 to 226-N or 266-1 to 266-N, or the transmit/receive interface 2030. Examples of means for determining a range between the apparatus and the wireless node based on the at least one RTT and the quality of the at least one RTT may include at least one of the controller 234 or 274, or the processing system 2020. Examples of means for determining a location of the wireless node within a building based on the determined range and information relating to a layout of the building may include at least one of the controller 234 or 274, or the processing system 2020. Examples of means for generating a request message requesting that the wireless node provides the quality of the at least one RTT may include at least one of the controller 234 or 274, or the processing system 2020. Example of means for outputting the request message for transmission to the wireless node may include at least one of the transmit processor 224 or 264, the transceivers 226-1 to 226-N or 266-1 to 266-N, or the transmit/receive interface 2030. Examples of means for selecting one or more of the plurality of RTTs based on the qualities of the plurality of RTTs may include at least one of the controller 234 or 274, or the processing system 2020. Examples of means for determining the range between the apparatus and the wireless node based on the selected one or more of the plurality of RTTs may include at least one of the controller 234 or 274, or the processing system 2020. Examples of means for selecting one of the plurality of spatial channels based on the qualities of the plurality of RTTs may include at least one of the controller 234 or 274, or the processing system 2020. Examples of means for generating a communication signal may include at least one of the controller 234 or 274, or the processing system 2020. Examples of means for outputting the communication signal for transmission to the wireless node via the selected one of the plurality of spatial channels may include at least one of the transmit processor 224 or 264, the transceivers 226-1 to 226-N or 266-1 to 266-N, or the transmit/receive interface 2030.

Examples of means for receiving, from the wireless node, a plurality of acknowledgements may include at least one of the receive processor 242 or 282, the transceivers 226-1 to 226-N or 266-1 to 266-N, or the transmit/receive interface 2030. Examples of means for receiving at least one acknowledgement from the wireless node, the acknowledgement acknowledging reception of the at least one timing measurement or ranging frame at the wireless node, may include at least one of the receive processor 242 or 282, the transceivers 226-1 to 226-N or 266-1 to 266-N, or the transmit/receive interface 2030. Examples of means for determining an arrival time of the at least one acknowledgement at the apparatus may include at least one of the controller 234 or 274, or the processing system 2020. Examples of means for outputting the determined arrival time for transmission to the wireless node may include at least one of the transmit processor 224 or 264, the transceivers 226-1 to 226-N or 266-1 to 266-N, or the transmit/receive interface 2030. Examples of means for measuring power of the received at least one acknowledgement at a plurality of sample times to obtain a plurality of power samples may include at least one of the receive processor 242 or 282, the controller 234 or 274, or the processing system 2020. Examples of means for determining a first one of the plurality of power samples that is greater than a threshold may include at least one of the controller 234 or 274, or the processing system 2020. Examples of means for determining the arrival time based on the sample time of the first one of the plurality of power samples may include at least one of the controller 234 or 274, or the processing system 2020. Examples of means for determining the threshold based on at least one of a receive signal strength indicator (RSSI) of the received at least one acknowledgement or a signal-to-noise ratio (SNR) of the received at least one acknowledgement may include at least one of the controller 234 or 274, or the processing system 2020.

Examples of means for determining a channel between the apparatus and the wireless node based on the received at least one acknowledgement may include at least one of the controller 234 or 274, or the processing system 2020. Examples of means for selecting one of a plurality of thresholds based on the determined channel may include at least one of the controller 234 or 274, or the processing system 2020. Examples of means for using the selected one of the plurality of thresholds for the threshold may include at least one of the controller 234 or 274, or the processing system 2020. Examples of means for determining a plurality of arrival times for the at least one acknowledgement based on a plurality of different thresholds may include at least one of the controller 234 or 274, or the processing system 2020. Examples of means for determining a channel between the apparatus and the wireless node based on the received at least one acknowledgement may include at least one of the controller 234 or 274, or the processing system 2020. Examples of means for determining a set of weights based on the determined channel may include at least one of the controller 234 or 274, or the processing system 2020. Examples of means for computing a weighted sum of the plurality of arrival times using the determined set of weights, wherein each one of the plurality of arrival times is weighted by a respective weight in the determined set of weights, may include at least one of the controller 234 or 274, or the processing system 2020.

FIG. 21 illustrates an exemplary timing diagram 2100 of frame transmissions in a system utilizing NDP soundings for range determination according to an aspect of the present disclosure. The diagram 2100 illustrates frame transmissions for both an initiator device (ISTA) and a responder device (RSTA). During sounding measurement phase, the initiator device (ISTA) may issue a ranging NDP announcement frame (NDP-A) 2102 to a responder device (RSTA). The NDP-A frame 2102 signals to the responder that ranging measurements are going to be performed using further NDP frames.

In particular, after a short interframe space (SIFS) time 2104, which is normally the amount of time that is required for a wireless device to process a received frame and to respond with a response frame, an initiator NDP frame 2106 (known also as an uplink (UL) NDP frame) is transmitted by the initiator device ISTA to the responder device RSTA. In response to receiving NDP frame 2106 and after another SIFS time period 2108, the responder RSTA transmits a responder NDP frame 2110 (known also as a downlink (DL) NDP frame) to the initiator device ISTA.

NDP frames 2106 and 2110 may be utilized for measurement of the RTT, for example, and calculation of the RTT, as well as RTT quality, may be effectuated according to any of the various methods disclosed previously in connection with FTM frames. As may be seen in FIG. 21, at a time demarcated at line 2112, the sequence of frames transmitted prior to this time 2112 are part of the measurement sounding period, and after time 2112, the processes of measurement calculation and measurement reporting are performed. In reporting the measurements, such as timing measurement involved in determining RTT, a location measurement report (LMR) as shown by frame 2114 may be transmitted from the responder RSTA to the initiator ISTA according to the proposed IEEE 802.11az standard, for example. Furthermore, the initiator device ISTA may be configured to determine both the RTT and an RTT quality according to any of the various processes discussed earlier. In an aspect, the time sequence 2100 may include a feedback frame 2116 that is transmitted from the initiator device (ISTA) to responder device (RSTA) to report the measured RTT and RTT quality to the responder device RSTA. This feedback frame may be configured as an LMR, a modified LMR to include the RTT and RTT quality information, or transmitted in conjunction with the LMR; i.e., either prior to, concurrent with, or subsequent to the timing of the LMR 2116.

Of further note, the example of FIG. 21 is shown in the context of a non-trigger based (TB) ranging sequence according to proposals under the IEEE 802.11az standard. Those skilled in the art will appreciate that the presently disclosed concepts may also be applied to a TB ranging sequence, such as a sequence where an access point (AP) triggers measurement sounding for two or more wireless devices or stations (STAs). In such case, feedback frames similar to frame 2116 may be transmitted from the STAs to the AP to report the measured RTT and RTT quality.

FIG. 22 illustrates an exemplary timing diagram 2200 showing an example of a feedback frames for a trigger based system including measurement feedback from an ISTA to an RSTA in a system using NDP frames. Additionally, in this example, it is assumed that an AP triggers sounding and measurement reporting of a plurality of wireless devices or stations indicated as an “n” number. As shown, the timing diagram illustrates frame transmissions over time verses frequency usage for the various frames. The initial sequences before measurement reporting include a polling part 2202, which is a poll or request to stations or wireless devices to participate in sounding measurements in the particular timeframe. Further, initial sequences including the sounding measurement part 2204, which was discussed before and may be implemented through any of the various methods for sounding or range measurements as disclosed herein, or that are known in the art.

During the measurement reporting phase or part 2206, the various stations may transmit LMRs with the sounding measurements (e.g., RTT timing measurements) from the responder stations (RSTAs) to initiator stations (ISTAs) as shown by n number of frames 2208₁ to 2208ₙ separated according to frequency bands or ranges within the available frequency bandwidth, although the reporting need not be limited to such frequency division.

Additionally, the reporting part 2206 may include a trigger frame (TF) ranging report 2210 transmitted by an RSTA to solicit the transmission of one or more ISTA-to-RSTA LMR frames, such as LMR frames 2212₁ to 2212ₙ. This TF report 2210 may also be configured to allocate uplink resources to ISTAs that negotiated ISTA-to-RSTA LMRs and were allocated resources in the preceding measurement sounding part 2204. In a further aspect, the LMR frames 2212₁ to 2212ₙ may include RTT and RTT quality information with the LMR frames 2212. In an alternative aspect, LMR frames 2212 may be appended with another NDP frame or frames as shown by frames 2214₁ to 2214ₙ, as merely one example. Although not illustrated in FIG. 22, in other aspects, the RTT and RTT quality information frames may be transmitted concurrent in time with the LMR frames 2212₁ to 2212ₙ, wherein frequency range may be further divided to accommodate the concomitant transmission of frames 2212₁ to 2212ₙ and frames 2214₁ to 2214ₙ.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system (e.g., the processing system 2020) in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of an access terminal 220 (see FIG. 2), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

One or more processors may be responsible for managing the bus and general processing, including the execution of software stored on the machine-readable media. The processors may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by an access terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that an access terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
an interface configured to receive, from a wireless node, at least one ranging frame; and
a processing system configured to:
determine at least one round trip time (RTT) between the apparatus and the wireless node based on the received at least one ranging frame;
determine a quality of the at least one RTT based on the received at least one ranging frame; and
generate a feedback frame comprising the at least one RTT and the quality of the at least one RTT;
wherein the interface is further configured to output the feedback frame for transmission to the wireless node.

2. The apparatus of claim 1, wherein the at least one ranging frame comprises one of Fine Timing Measurement (FTM) frame or a null data packet (NDP) frame.

3. The apparatus of claim 1, wherein the quality of the at least one RTT comprises at least one of a numerical rating for the at least one RTT or a time error range for the at least one RTT.

4. The apparatus of claim 1, wherein:
the at least one range frame comprises a plurality of ranging frames;
the at least one RTT comprises a combined RTT; and
the processing system is configured to determine the combined RTT by:
for each one of the received plurality of ranging frames, determining a respective RTT based on the one of the received plurality of ranging frames; and
combining the determined RTTs for the plurality of ranging frames to obtain the combined RTT.

5. The apparatus of claim 4, wherein:
the quality of the at least one RTT comprises a quality of the combined RTT; and
the processing system is configured to determine the quality of the combined RTT by:
for each one of the determined RTTs, determining a respective quality based on the respective one of the plurality of ranging frames; and
combining the qualities of the determined RTTs to obtain the quality of the combined RTT.

6. (canceled)

7. The apparatus of claim 1, wherein:
the processing system is configured to generate a message indicating that the apparatus is capable of providing the quality of the at least one RTT; and
the interface is configured to output the message for transmission to the wireless node.

8. The apparatus of claim 1, wherein:
the at least one ranging frame comprises a plurality of ranging frames;
the at least one RTT comprises a plurality of RTTs;
the quality of the at least one RTT comprises a quality of each one of the plurality of RTTs;
the processing system is configured to determine each one of the plurality of RTTs based on a respective one of the received plurality of ranging frames; and
the processing system is configured to determine the quality of each one of the plurality of RTTs based on the respective one of the received plurality of ranging frames.

9-13. (canceled)

14. The apparatus of claim 1, wherein:
the processing system is configured to determine the quality of the at least one RTT by:
measuring power of the received at least one ranging frame at a plurality of sample times to obtain a plurality of power samples;
determining a first peak power sample in the plurality of power samples that is greater than a threshold; and
determining the quality of the at least one RTT based on the first peak power sample.

15. The apparatus of claim 14, wherein the processing system is configured to determine the quality of the at least one RTT based on the first peak power sample by:
summing the plurality of power samples to obtain a total power; and
determining the quality of the at least one RTT based on a ratio of the first peak power sample over the total power.

16. The apparatus of claim 14, wherein the processing system is configured to determine the threshold by one of:
(1) determining a strongest peak power sample in the plurality of power samples; and
multiplying the strongest peak power sample by a scaling factor to obtain the threshold; or
(2) determining a noise power; and
multiplying the noise power by a scaling factor to obtain the threshold.

17-18. (canceled)

19. The apparatus of claim 14, wherein the processing system is configured to:
determine a group of power samples in the plurality of power samples that are located within a time interval of the first peak power sample in time;
wherein the processing system is configured to determine the quality of the at least one RTT based also on the group of power samples.

20. The apparatus of claim 1, wherein:
the processing system is configured to determine the quality of the at least one RTT by:
measuring power of the received at least one ranging frame at a plurality of sample times to obtain a plurality of power samples;
determining a first one of the plurality of power samples that is greater than a threshold;
determining a last one of the plurality of power samples that is greater than the threshold;
determining a delay spread between the first one of the plurality of power samples and the last one of the plurality of power samples; and
determining the quality of the at least one RTT based on the determined delay spread.

21-24. (canceled)

25. The apparatus of claim 1, wherein the processing system is configured to determine the quality of the at least one RTT based on at least one of a receive signal strength indicator (RSSI) of the received at least one ranging frame, a signal-to-noise ratio (SNR) of the received at least one ranging frame, a noise power of the received at least one ranging frame, a bandwidth of the at least one received ranging frame, or a type of the received at least one ranging frame.

26-32. (canceled)

33. A method for wireless communications, comprising:
receiving, from a wireless node, at least one ranging frame;
determining at least one round trip time (RTT) between an apparatus and the wireless node based on the received at least one ranging frame;
determining a quality of the at least one RTT based on the received at least one ranging frame;
generating a feedback frame comprising the at least one RTT and the quality of the at least one RTT; and
outputting the feedback frame for transmission to the wireless node.

34. The apparatus of claim 1, wherein the at least one ranging frame comprises one of Fine Timing Measurement (FTM) frame or a null data packet (NDP) frame.

35. The method of claim 33, wherein the quality of the at least one RTT comprises at least one of a numerical rating for the at least one RTT or a time error range for the at least one RTT.

36. The method of claim 33, wherein:
the at least one ranging frame comprises a plurality of ranging frames;
the at least one RTT comprises a combined RTT; and
determining the at least one RTT comprises:
for each one of the received plurality of ranging frames, determining a respective RTT based on the one of the received plurality of ranging frames; and
combining the determined RTTs for the plurality of ranging frames to obtain the combined RTT.

37. The method of claim 36, wherein:
the quality of the at least one RTT comprises a quality of the combined RTT; and
determining the quality of the at least one RTT comprises:
for each one of the determined RTTs, determining a respective quality based on the respective one of the plurality of ranging frames; and
combining the qualities of the determined RTTs to obtain the quality of the combined RTT.

38. (canceled)

39. The method of claim 33, further comprising:
generating a message indicating a capability of providing the quality of the at least one RTT; and
outputting the message for transmission to the wireless node.

40. The method of claim 33, wherein:
the at least one ranging frame comprises a plurality of ranging frames;
the at least one RTT comprises a plurality of RTTs;
the quality of the at least one RTT comprises a quality of each one of the plurality of RTTs;
determining the at least one RTT comprises determining each one of the plurality of RTTs based on a respective one of the received plurality of ranging frames; and
determining the quality of the at least one RTT comprises determining the quality of each one of the plurality of RTTs based on the respective one of the received plurality of ranging frames.

41-46. (canceled)

47. The method of claim 33, wherein determining the quality of the at least one RTT comprises:
measuring power of the received at least one ranging frame at a plurality of sample times to obtain a plurality of power samples;
determining a first peak power sample in the plurality of power samples that is greater than a threshold; and
determining the quality of the at least one RTT based on the first peak power sample.

48. The method of claim 47, wherein determining the quality of the at least one RTT based on the first peak power sample comprises:
summing the plurality of power samples to obtain a total power; and
determining the quality of the at least one RTT based on a ratio of the first peak power sample over the total power.

49. The method of claim 47, further comprising determining the threshold, wherein determining the threshold comprises at least one of:
(1) determining a strongest peak power sample in the plurality of power samples; and
multiplying the strongest peak power sample by a scaling factor to obtain the threshold; or.
(2) determining a noise power; and
multiplying the noise power by a scaling factor to obtain the threshold.

50-51. (canceled)

52. The method of claim 33, wherein determining the quality of the at least one RTT comprises:
measuring power of the received at least one ranging frame at a plurality of sample times to obtain a plurality of power samples;
determining a first one of the plurality of power samples that is greater than a threshold;
determining a last one of the plurality of power samples that is greater than the threshold;
determining a delay spread between the first one of the plurality of power samples and the last one of the plurality of power samples; and
determining the quality of the at least one RTT based on the determined delay spread.

53. The method of claim 52, further comprising determining the threshold, wherein determining the threshold comprises:
determining a strongest peak power sample in the plurality of power samples; and
multiplying the strongest peak power sample by a scaling factor to obtain the threshold.

54-56. (canceled)

57. The method of claim 33, wherein determining the quality of the at least one RTT comprises determining the quality of the at least one RTT based on at least one of a receive signal strength indicator (RSSI) of the received at least one ranging frame, a signal-to-noise ratio (SNR) of the received at least one ranging frame, a noise power of the received at least one ranging frame, a bandwidth of the at least one received ranging frame, or a type of the received at least one ranging frame.

58-64. (canceled)

65. An apparatus for wireless communications, comprising:
means for receiving, from a wireless node, at least one ranging frame;
means for determining at least one round trip time (RTT) between an apparatus and the wireless node based on the received at least one ranging frame;
means for determining a quality of the at least one RTT based on the received at least one ranging frame;
means for generating a feedback frame comprising the at least one RTT and the quality of the at least one RTT; and
means for outputting the feedback frame for transmission to the wireless node.

66-96. (canceled)

97. A computer readable medium comprising instructions stored thereon for:
receiving, from a wireless node, at least one ranging frame;
determining at least one round trip time (RTT) between an apparatus and the wireless node based on the received at least one ranging frame;
determining a quality of the at least one RTT based on the received at least one ranging frame;
generating a feedback frame comprising the at least one RTT and the quality of the at least one RTT; and
outputting the feedback frame for transmission to the wireless node.

98-153. (canceled)

154. The apparatus of claim 65, wherein the at least one ranging frame comprises one of Fine Timing Measurement (FTM) frame or a null data packet (NDP) frame.

155. The computer readable medium of claim 97, wherein the at least one ranging frame comprises one of Fine Timing Measurement (FTM) frame or a null data packet (NDP) frame.
